(19) United States
(12) Patent Application Publication
(10) Pub. No.: US 2008/0316249 A1
(43) Pub. Date: Dec. 25, 2008

(54) LIQUID SEALING STRUCTURE, MANUFACTURING METHOD OF THE SAME, LIQUID CONTAINER, REFILLED LIQUID CONTAINER, AND REFILLING METHOD OF THE SAME

(75) Inventors: Yuji Aoki, Matsumoto-shi (JP); Hitotoshi Kimura, Matsumoto-shi (JP); Izumi Nozawa, Matsumoto-shi (JP)

Correspondence Address: SUGHRUE MION, PLLC, 2100 Pennsylvania Avenue, N.W., Washington, DC, 20037, US

(73) Assignee: SEIKO EPSON CORPORATION, Tokyo (JP)

(21) Appl. No.: 12/033,501

(22) Filed: Feb. 19, 2008

(30) Foreign Application Priority Data
Feb. 19, 2007 (JP) 2007-037993
May 18, 2007 (JP) 2007-132728
Jul. 9, 2007 (JP) 2007-179755

(51) Int. Cl. B41J 2/175; B41J 29/393; B21D 53/76

(52) U.S. Cl. 347/19; 347/87; 29/890.1

(57) ABSTRACT

A liquid sealing structure includes: a liquid lead-out portion which has a liquid passage and an opening end surface formed in a liquid lead-out end of the liquid passage; a sealing member which is disposed on the opening end surface inside the liquid passage; a valve mechanism which is disposed inside the sealing member in the liquid passage to close the liquid passage; and a sealing film which covers the liquid passage and the opening end surface of the liquid lead-out portion and is thermally welded to the opening end surface and the sealing member, wherein a notch portion for passing a liquid lead-out member which is inserted into the liquid passage to open the valve mechanism is formed in the sealing film.

### BACKGROUND

1. Technical Field

The present invention relates to a liquid sealing structure suitable for an ink cartridge for a printer, a manufacturing method of the same, a liquid container, a refilled liquid container, and a refilling method of the same.

2. Related Art

In the past, an ink jet type printer as a liquid ejecting apparatus for ejecting liquid drops through a nozzle of a liquid ejecting head was known. The ink jet type printer has an off-carriage type ink supply system for mounting an ink cartridge on a portion other than a carriage. As a case where the ink jet type printer has the off-carriage type ink supply system, a case where a printer has a large-scale ink cartridge in order to print a large paper sheet and a case where an ink jet type printer is not mounted with an ink cartridge by reducing the size of the carriage to reduce the size of the ink jet type printer or make it thin.

In the off-carriage type ink supply system, for example, the ink cartridge is disposed in the container body. In addition, ink is supplied to a sub tank or the like mounted in the carriage from the ink cartridge with an ink supply tube interposed therebetween. However, when a flow amount of ink becomes increased to realize a high speed printing or a high precise printing of a printer, there arises a problem that ink cannot be sufficiently supplied to a sub-tank due to increase in a dynamic pressure of the ink supply tube.

In order to solve such a problem, an ink cartridge which receives a bag-like ink pack in a case of the ink cartridge to introduce air between the case and the ink pack and pressurizes the ink pack to forcedly lead out ink was suggested (JP-A-2001-212973).

An ink lead-out portion having a valve mechanism is connected to the ink pack and an opening is provided in the case to expose the ink lead-out portion from the case. In addition, the opening of the case is sealed by thermally welding an end surface of the ink lead-out portion and the case around the opening to the sealing film (FIG. 5 in JP-A-2005-59322).

The ink lead-out portion is provided with an ink passage. A sealing member formed of an elastic ring closely inserted into an inner wall of the ink passage, a movable valve member disposed so as to come in contact with the sealing member, and a coil spring urging so as to bring the valve member in pressing-contact with the sealing member are disposed in the ink passage. Moreover, an ink lead-out needle tears the sealing film to be inserted into the ink passage. The sealing member also serves as a valve sheet member which blocks the ink passage by coming in pressing-contact with the valve member by the coil spring before the ink lead-out needle is inserted. When the ink lead-out needle tears the sealing film and is inserted into the ink passage, the ink lead-out needle separates the valve member from the sealing member against an urging force of the coil spring to open the ink passage.

When the ink passage is opened, ink has to be led out only from an ink passage formed in the ink lead-out needle. Accordingly, the sealing member is formed as an elastic ring to elastically seal a gap between the ink lead-out needle and a gap between the sealing member and the inner wall of the ink passage.

However, if roundness of the ink passage of the ink lead-out portion deteriorates, for example, elastic sealing of the sealing member and the inner wall of the ink passage may be incomplete. Accordingly, the ink leakage is generated. In addition, the ink is pressurized and supplied like JP-A-2001-212973. At this time, if elastic sealing of the sealing member and the inner wall of the ink passage is weak, the sealing may deteriorate due to the fed ink. Moreover, if the ink cartridge falls or the ink cartridge is vibrated, the sealing between the sealing member and the inner wall of the ink passage may temporarily deteriorate.

Such problems are not limited to the ink cartridge, but may be generated in every apparatus in which an inner wall of a liquid passage formed in a liquid lead-out portion and a sealing member are elastically sealed. For example, in an off-carriage or an on-carriage of a printer, such type of the ink lead-out portion is disposed in any connection portion of the ink passage. As well as the printer, the same structure may be used even in a liquid fuel lead-out portion of a liquid fuel cartridge (FIG. 5 in JP-A-2003-331879) or a connection portion of a gas passage.

### SUMMARY

An advantage of some aspects of the invention is that it provides a liquid sealing structure, a manufacturing method of the same, a refilling liquid container, and a refilling method of the same capable of preventing problems at the time of inserting a liquid lead-out member and reliably prevent liquid leakage from a gap between an inner wall of a liquid passage and a sealing member without depending on elastic sealing of the inner wall of the liquid passage formed in the liquid lead-out member and the sealing member.

According to an aspect of the invention, there is provided a liquid sealing structure including: a liquid lead-out portion which has a liquid passage and an opening end surface formed in a liquid lead-out end of the liquid passage; a sealing member which is disposed on the opening end surface inside the liquid passage; a valve mechanism which is disposed inside the sealing member in the liquid passage to close the liquid passage; and a sealing film which covers the liquid passage and the opening end surface of the liquid lead-out portion and is thermally welded to the opening end surface and the sealing member. In the liquid sealing structure, a notch portion for passing a liquid lead-out member which is inserted into the liquid passage to open the valve mechanism is formed in the sealing film.

According to the liquid sealing structure having the above-described configuration, the sealing film which is thermally welded seals the gap between the inner wall of the liquid passage and the outer wall of the sealing member. Accordingly, it is not necessary to depend on the sealing of the sealing member having poor precision of the roundness of the liquid passage and the inner wall of the liquid passage. Moreover, even if the sealing of the sealing member and the inner wall of the liquid passage temporarily deteriorate due to falling or vibration of the liquid lead-out portion, it is possible to reliably prevent liquid leakage by use of the sealing film which is thermally welded.

According to the liquid sealing structure having the above-described configuration, the notch portion is formed in the sealing film. In the liquid sealing structure having the above-described configuration, the valve mechanism for opening the liquid passage is formed in the liquid passage. Accordingly, even when the notch portion is formed in the sealing film, the liquid leakage is not generated from the notch portion as long as the valve mechanism is driven in a close state. The notch portion facilitates insertion of the liquid lead-out member when the liquid lead-out member for opening the valve mechanism is inserted into the liquid passage. That is, the liquid lead-out member is inserted into the notch portion formed in the sealing film or is guided to the notch portion to tear the sealing film to be guided to the liquid passage through the notch portion. With such a configuration, it is possible to apply no pressure to the sealing film or reduce a pressure applied to the sealing film when the liquid lead-out member passes through the notch portion.

Such a notch portion may be polygon such as a circle or triangle, a hole such as a star shape, a plurality of notches radially extending from the center point thereof. In addition, it is preferable that the size of the notch portion is larger than the largest diameter of the liquid lead-out member, but the size of the notch portion may be smaller. In the latter case, the liquid lead-out member further tears the notch portion, and therefore the size of the notch portion becomes increased so that the liquid the liquid lead-out member can be inserted. However, resistance when the liquid lead-out member is inserted becomes reduced.

According to the liquid sealing structure having the above-described configuration, the sealing member is formed of an elastic ring having a hole through which the liquid lead-out member is closely inserted. In this case, the sealing member formed of the elastic ring exerts sealing with an outer wall of the liquid lead-out member by tightening.

According to the liquid sealing structure having the above-described configuration, the valve mechanism may further include a movable valve member which is disposed to come in contact with the sealing member inside the liquid passage and an urging member that urges the valve member to come in pressing contact with the sealing member. With such a configuration, the sealing member serves as a valve sheet member which comes in contact with the valve member to close the liquid passage before the liquid lead-out member is inserted through the sealing member, and the valve member is separated from the sealing member against an urging force of the urging member by the liquid lead-out member to open the liquid passage when the liquid lead-out member passes through the sealing film to be inserted into the liquid passage.

According to the liquid sealing structure having the above-described configuration, the opening end surface includes a first thermal welding support circularly protruding and the sealing member includes a second thermal welding support protruding circularly. In addition, the first thermal welding support and the second thermal welding support can be thermally welded with the sealing film. In this way, it is possible to limit the thermally welding area, thereby reducing the pressure of the thermal welding and a thermal welding period of time. Moreover, it is possible to determine thermally welding time by presence or non-presence of the thermally welding supports, thereby equalizing the thermal welding.

According to the liquid sealing structure having the above-described configuration, the sealing member can perform a positioning operation by bring the outer surface of the sealing member in contact with the inner wall of the liquid passage.

That is, it is not necessary to seal the sealing member and the liquid passage and the positioning may be maintained. When the sealing member performs a positioning operation, the position of the sealing member is equalized in the thermal welding. Accordingly, it is possible to reduce inferiority.

According to the liquid sealing structure having the above-described configuration, the liquid lead-out portion, the sealing member, and the sealing film may include a polyolefin material. The polyolefin material is a material contacting with a liquid such as ink and has high reliability. The thermal welding is guaranteed by using the same material.

According to the liquid sealing structure having the above-described configuration, as the polyolefin material which is the material contacting with a liquid such as ink, polyprophylene or polyethylene can be used. Finding the sealing material capable of performing the thermal welding was the start of the invention.

According to the liquid sealing structure having the above-described configuration, the sealing film is formed of a plurality of layers having different materials and the most end layer facing the liquid lead-out portion and the sealing member may be formed of the polyolefin material. With such a configuration, it is possible to guarantee the thermal welding and also having a property of a material different from the thermally welded layer. For example, the layer close to the most end layer can be formed of a material having a melting point higher than that of the polyolefin material. Accordingly, it is possible to retain the shape of the sealing film even after the thermal welding.

According to the liquid sealing structure having the above-described configuration, the sealing film may be formed of thermoplastic elastomer containing the polyolefin material. The thermoplastic elastomer can exert the good thermal welding along with the above-described polyprophylene or polyethylene.

According to another aspect of the invention, there is provided a liquid container including a liquid containing member which contains a liquid and the liquid sealing structure having the above-described configuration which is connected to a liquid lead-out port of the liquid level detecting unit.

In this case, the liquid container may further include a case in which a space for receiving the liquid containing member and the liquid sealing structure connected to the liquid containing member. The case can a pressurizing port into which a pressurizing fluid for feeding the liquid contained in the liquid container is introduced and an opening for exposing the opening end surface of the liquid sealing structure. In addition, the sealing film can be thermally welded to the case around the opening. In this way, the sealing of the pressurizing fluid can also serve as a sealing film.

The liquid container having the above-described configuration may further include a liquid level detecting unit which is connected to the liquid containing member. The liquid level detecting unit can include the liquid lead-out member which is inserted into the liquid passage through the notch portion of the sealing film.

In this case, the liquid lead-out member may include a cylindrical member having a flow passage formed therein and a slit which is formed from an insertion end surface of the cylindrical member toward a circumferential wall of the cylindrical member to communicate with the flow passage, wherein the insertion end surface of the cylindrical member has a flat surface.

In this way, when the front end of the liquid lead-out member has not a needle shape, but has a flat portion, for example, it is possible to easily the liquid lead-out member by forming the notch portion in the sealing film.

According to still another aspect of the invention, there is provided a liquid container including: a liquid containing member which contains a liquid; a liquid level detecting unit which is connected to the liquid containing member; and the liquid sealing structure according to claim 1 which is connected to a liquid lead-out port of the liquid level detecting unit. That is, the liquid sealing structure according the invention may not be directly connected to the liquid containing member, but may be connected to the liquid lead-out port of the liquid level detecting unit.

According to still another aspect of the invention, there is provided a method of manufacturing a liquid sealing structure which includes a liquid lead-out portion which has a liquid passage and an opening end surface formed in a liquid lead-out end of the liquid passage, a sealing member which is disposed on the opening end surface inside the liquid passage, and a valve mechanism which is disposed inside the sealing member in the liquid passage to close the liquid passage, the method including: disposing the valve mechanism and the sealing member inside the liquid passage of the liquid lead-out portion; thermally welding a sealing film to the opening end surface and the sealing member of the liquid lead-out portion; and forming in the sealing film a notch portion for passing a liquid lead-out member which is inserted into the liquid passage to open the valve mechanism is formed in the sealing film before or after the thermal welding.

In this way, forming the notch portion in the sealing film may be performed before the sealing film is thermally welded or after the sealing film is thermally welded.

Disposing the sealing member so as to be substantially flush with the opening end surface may be performed before the thermal welding. It is possible to reliably and simply the thermal welding by making the sealing member substantially flush with the opening end surface.

In this case, in the inserting of the sealing member, the outer surface of the sealing member may be brought in contact with the inner wall of the liquid passage and the positing of the sealing member may be performed to make the opening end surface flush with the sealing member. That is because making the opening end surface flush with the sealing member is mechanically guaranteed.

Moreover, in the inserting of the sealing member, the second thermally welding support circularly protruding to the sealing member is configured so as to be flush with the first thermally welding support circularly protruding to the opening end surface. In addition, in the thermal welding, it is possible to melt and thermally weld the first and second thermally welding supports to the sealing film. Since the thermally welding area can be limited, it is possible to reduce the pressure of the thermal welding and the thermal welding period of time. Moreover, it is possible to determine thermally welding time by presence or non-presence of the thermally welding supports, thereby equalizing the thermal welding.

The notch portion may be formed in the sealing film. In this case, a processing instrument provided in an apparatus used in the thermal welding may be used.

According to still another aspect of the invention, there is provided a method of manufacturing a liquid container including: manufacturing the liquid sealing structure according to claim 11; connecting the liquid sealing structure to a liquid containing member containing a liquid; filling the liquid in the liquid containing member by inserting a liquid filling member into the liquid passage through the notch portion of the sealing film, and opening the valve mechanism by the use of the liquid filling member; and disposing the liquid containing member and the liquid sealing structure in a case.

In this case, the notch portion is formed in the sealing film before filling a liquid in the liquid containing member. Accordingly, when the liquid is filled in the liquid containing member using the liquid filling member, the liquid filling member is inserted into the liquid passage through the notch portion of the sealing film, thereby opening the valve mechanism to fill the liquid. Therefore, the notch portion of the sealing film is helpful even when the liquid filling member passes through the notch portion in the liquid filling. Of course, the liquid contained in the liquid containing member is led out and used after the liquid filling. However, even at this time, the liquid lead-out member can pass through the notch portion of the sealing film.

According to the above-described method of manufacturing a liquid container, a liquid level detecting unit may be disposed in the case and the liquid sealing structure and the liquid level detecting unit may be connected to each other by inserting the liquid lead-out member provided in the liquid level detecting unit into the liquid passage through the notch portion of the sealing film. That is, the liquid lead-out member may be provided as a part of the liquid level detecting unit.

According to still another aspect of the invention, there is provided a method of manufacturing a liquid container including: thermally welding a sealing film to an opening end surface and a sealing member of a liquid sealing structure, which includes a liquid lead-out portion which has the opening end surface formed at a liquid lead-out end of a liquid passage, the sealing member disposed on the opening end surface inside the liquid passage, and a valve mechanism disposed inside the sealing member in the liquid passage to close the liquid passage; connecting the liquid sealing structure to a liquid containing member containing a liquid; filling the liquid in the liquid containing member by inserting a liquid filling needle into the liquid passage of the liquid lead-out portion through the sealing film and the liquid sealing structure; and disposing the liquid containing member and the liquid sealing structure in a case, wherein in the filling of the liquid, the liquid filling needle tears the sealing film and a notch portion for passing a liquid lead-out member which is inserted into the liquid passage to open the valve mechanism is formed in the sealing film.

According to the method of manufacturing the liquid container, the notch portion can be formed in the sealing film by the liquid filling needle in the liquid filling.

According to still another aspect of the invention, there is provided a refilled liquid container including: a liquid containing member which contains a liquid; and a liquid sealing structure which is connected to the liquid containing member, in which a liquid container is recovered and the liquid containing member is refilled with a liquid, the liquid sealing structure including a liquid lead-out portion which has a liquid passage and an opening end surface formed in a liquid lead-out end of the liquid passage, a sealing member which is disposed on the opening end surface inside the liquid passage, and a sealing film which covers the liquid passage and the opening end surface of the liquid lead-out portion and is thermally welded to the opening end surface and the sealing member, wherein before the recovery, a valve mechanism is opened by inserting a liquid lead-out needle into the liquid passage with the sealing film interposed therebetween to lead out the liquid contained in the liquid containing member, wherein the thermal welding of the sealing film to the opening end surface and the sealing member is maintained, wherein the refilled liquid container further includes a coating film attached onto the sealing film, and wherein a notch portion for passing the liquid lead-out member re-inserted into the liquid passage is formed in the coating film.

With such a configuration, it is possible to re-use the recovered liquid container as the refilled liquid container just by further providing the coating film while re-using a sealing function of the torn sealing film before the recovery or the sealing film having the notch portion. In addition, it is possible to guarantee commodity value of the recovered liquid container. When the recovered liquid container is used in the next time, in the liquid filling, the liquid filling member is inserted into the liquid passage through the notch portion of the coating film and the notch portion or the torn portion formed in the sealing film. In addition, upon leading out the liquid, the liquid lead-out member is inserted into the liquid passage through the notch portion of the coating film and the notch portion or the torn portion formed in the sealing film.

According to still another aspect of the invention, there is provided a method of refilling a liquid container including a liquid containing member which contains a liquid and a liquid sealing structure which is connected to the liquid containing member, in which a liquid container is recovered and the liquid containing member is refilled with a liquid, the liquid sealing structure including a liquid lead-out portion which has a liquid passage and an opening end surface formed in a liquid lead-out end of the liquid passage, a sealing member which is disposed on the opening end surface inside the liquid passage, a valve mechanism which is disposed inside the sealing member in the liquid passage to close the liquid passage and a sealing film which covers the liquid passage and the opening end surface of the liquid lead-out portion and is thermally welded to the opening end surface and the sealing member, and in which before the recovery, the valve mechanism is opened by inserting a liquid lead-out needle into the liquid passage with the sealing film interposed therebetween to lead out the liquid contained in the liquid containing member, the method including: refilling the liquid to the liquid containing member while maintaining sealing of the opening end surface by the thermal welding of the sealing film to the opening end surface and the sealing member; and attaching a coating film for coating the sealing film onto the sealing film after the refilling, wherein a notch portion for passing the liquid lead-out member re-inserted into the liquid passage after the refilling is formed in the coating film.

With such a configuration, it is possible to re-use the recovered liquid container as the refilled liquid container just by further providing the coating film while re-using the sealing function of the torn sealing film before the recovery or the sealing film having the notch portion. In addition, it is possible to guarantee the commodity value of the recovered liquid container. Even when the liquid container has the torn sealing film, it is possible to improve the commodity value by covering the torn portion by use of the coating film. Even when the sealing film having the notch portion is mounted, the notch portion of the sealing film is deformed due to repeated use. Accordingly, it is possible to improve the commodity value by covering the torn portion by use of the coating film. When the recovered liquid container is used in the next time, in the liquid filling, the liquid filling member is inserted into the liquid passage through the notch portion of the coating film and the notch portion or the torn portion formed in the sealing film. In addition, upon leading out the liquid, the liquid lead-out member is inserted into the liquid passage through the notch portion of the coating film and the notch portion or the torn portion formed in the sealing film.

### BRIEF DESCRIPTION OF THE DRAWINGS

The invention will be described with reference to the accompanying drawings, wherein like numbers reference like elements.

FIG. 1 is a perspective view illustrating a printer according to a first embodiment of the invention.

FIG. 2 is an exploded perspective view illustrating the printer in FIG. 1.

FIG. 3 is an exploded perspective view illustrating an ink cartridge in FIG. 1.

FIG. 4 is a partially sectional view illustrating the ink cartridge.

FIG. 5 is a partially section view illustrating the ink cartridge when an ink lead-out needle is inserted.

FIG. 6 is an exploded perspective view illustrating a liquid sealing structure according to a second embodiment of the invention.

FIG. 7 is a sectional view illustrating the liquid sealing structure in FIG. 6 before a sealing film is thermally welded.

FIG. 8 is an exploded perspective view illustrating an ink cartridge according to a third embodiment of the invention.

FIG. 9A is a perspective view illustrating an ink pack mounted in a bag member receiving portion and FIG. 9B is an enlarged view illustrating an IXB portion in FIG. 9A.

FIG. 10 is an exploded perspective view illustrating a liquid level detecting unit.

FIG. 11 is a perspective view illustrating the liquid level detecting unit.

FIG. 12 is a perspective view illustrating the liquid level detecting unit when viewed from the rear side.

FIGS. 13A and 13B are a front view and a sectional view illustrating an ink lead-out member provided in the liquid level detecting unit in FIG. 12.

FIG. 14 is a perspective view illustrating the fitted liquid level detecting unit.

FIG. 15A is an enlarged view illustrating a circuit board and the peripheral portion thereof and FIG. 15B is a sectional view taken along XVB-XVB in FIG. 15A.

FIG. 16 is a schematic perspective view illustrating a liquid container in a modification example in which a notch portion is not formed in a sealing film of a liquid level detecting unit.

FIG. 17 is a schematic perspective view illustrating a method of sealing a re-used ink lead-out portion according to a fourth embodiment of the invention.

FIG. 18 is a front view illustrating a re-used liquid level detecting unit.

FIG. 19 is a perspective view illustrating a coating film formed of a plurality of layers according to a fifth embodiment of the invention.

FIG. 20 is a diagram for explaining a step of forming a notch portion in a coating film using a jig in thermal welding.

### DESCRIPTION OF EXEMPLARY EMBODIMENTS

### First Embodiment

Hereinafter, an embodiment of the invention will be described in detail. The following embodiment does not limit the invention described in Claims, but all the elements described according to the embodiment are not necessary as means for solving the problems of the invention.

### Overall Configuration of Liquid Ejecting Apparatus

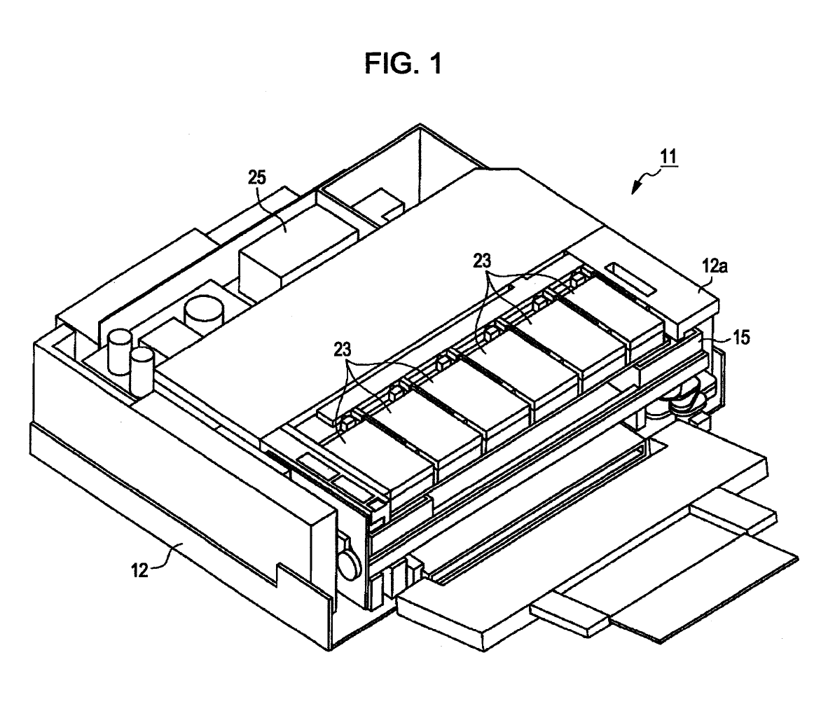

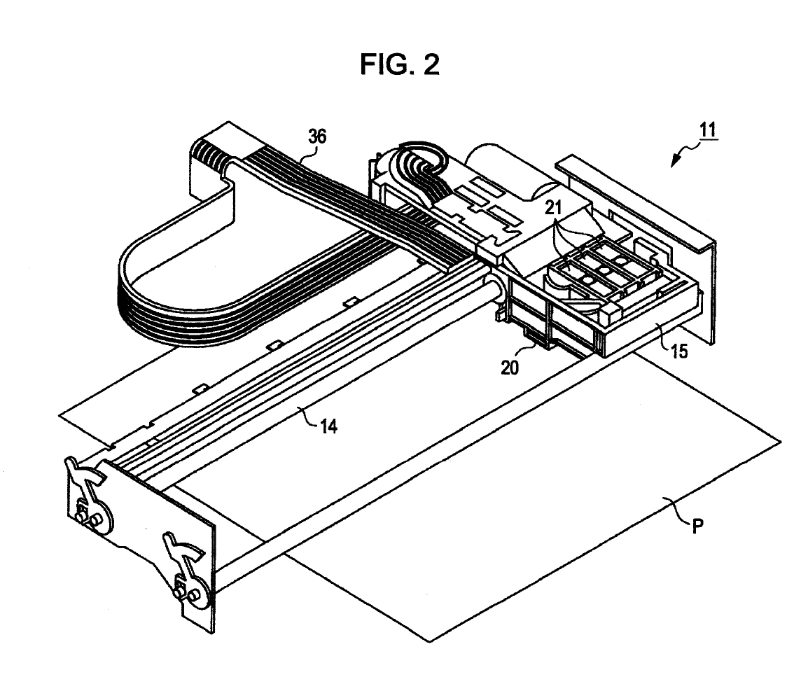

As shown in FIG. 1, as a liquid ejecting apparatus or a liquid consuming apparatus according to the embodiment, a printer 11 is covered with a frame 12. As shown in FIG. 2, a guide shaft 14, a carriage 15, a printing head 20 as a liquid ejecting head, valve units 21, ink cartridges 23 (see FIG. 1) as a liquid container, and a pressurizing pump 25 (see FIG. 1) are included in the frame 12.

As shown in FIG. 1, the frame 12 is a substantially rectangular box. A cartridge holder 12a is formed in the front surface of the frame 12.

As shown in FIG. 2, the guide shaft 14 is formed in a bar shape and is disposed in the frame 12. In the present embodiment, a direction in which the guide shaft 14 is disposed is referred to as a main scanning direction. The carriage 15 is inserted so as to be relatively movable with respect to the guide shaft 14 and can reciprocate in the main scanning direction. In addition, the carriage 15 is connected to a carriage motor (not shown) with a timing belt (not shown) interposed therebetween. The carriage motor is supported in the frame 12. The carriage 15 is driven by drive of the carriage motor in a state where the timing belt is interposed therebetween. In addition, the carriage 15 reciprocates along the guide shaft 14, that is, in the main scanning direction.

The printing head 20 disposed on the lower surface of the carriage 15 has a plurality of nozzles (not shown) for ejecting ink as a liquid. In addition, the printing head 20 performs a printing operation of printing data such as images or characters by ejecting ink drops on a printing medium such as a printing paper sheet. The valve units 21, which are mounted on the carriage 15, adjust a pressure and supply temporarily stored ink to the printing head 20.

In the present embodiment, one valve unit 21 is configured so as to adjust the pressure and individually supply two types of ink to the printing head 20. In addition, three valve units 21 are provided according to the present embodiment and correspond to 6 color ink (black, yellow, magenta, cyan, light magenta, and light cyan).

A platen (not shown) is disposed below the printing head 20. The platen supports the printing medium as a target fed in a sub-scanning direction perpendicular to the main scanning direction by a paper-feeding unit (not shown).

### Liquid Container

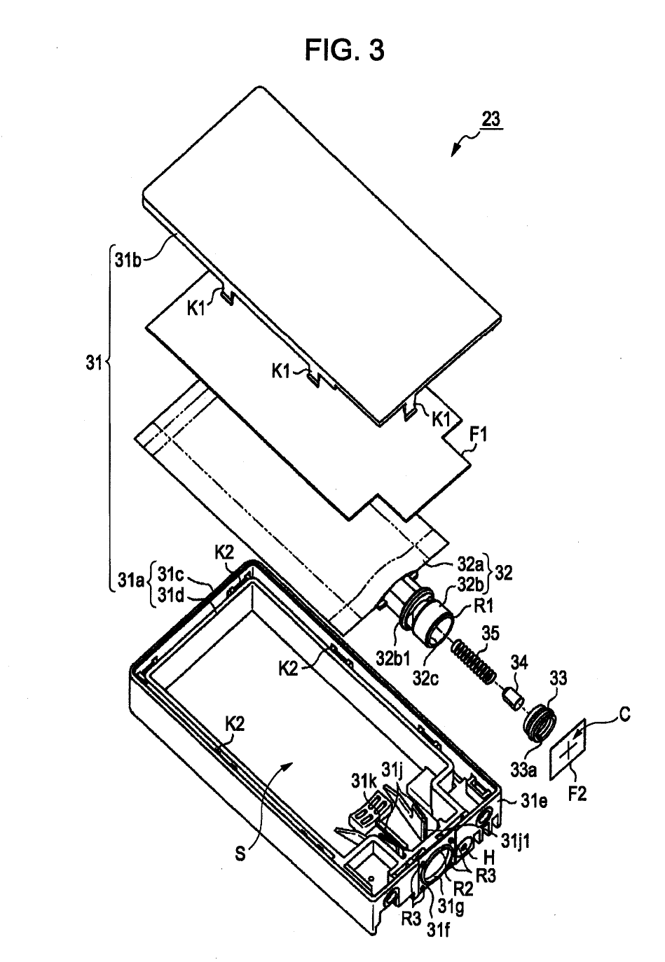

As shown in FIG. 1, ink cartridges 23 as the liquid containers are detachably attached to the cartridge holder 12a and six ink cartridges 23 are provided so as to correspond to the above-described color ink. A configuration of the ink cartridges 23 will be described with reference to FIGS. 3 to 5.

As shown in FIG. 3, each of the ink cartridges 23 includes a main case 31a, an upper case 31b, and an ink pack 32 as a liquid containing member. In addition, the main case 31a and the upper case 31b constitute an ink case 31. The ink pack 32 is received in the ink case 31. Only one of the six ink cartridges 23 is shown in FIG. 3. The remaining five ink cartridges 23 have the same structure as that thereof, and thus the figure is omitted.

As shown in FIG. 3, the ink pack 32 includes an ink bag 32a as a flexible member, an ink lead-out portion 32b as a liquid lead-out portion, and a sealing member 33. The ink bag 32a is formed of a material having a flexible property and a gag barrier property. For example, the ink bag 32a is formed by overlapping two laminate sealing films in which a nylon sealing film is formed in the outside and a polyprophylene or polyethylene sealing film is formed in the inside, and attaching the circumference thereof by thermal welding.

The ink lead-out portion 32b is made by, for example, polypropylene and is attached to the ink bag 32a by thermal welding or the like. Specifically, when the ink bag 32a is formed, three sides of two superimposed aluminum laminate sealing films are thermally welded, the ink lead-out portion 32b is attached to the middle of the one remaining side, and the one remaining side is thermally welded to form the ink pack 32. Ink in the ink bag 32a is received so as to be deaerated. The ink lead-out portion 32b is formed in a substantially cylindrical shape and the inside of the ink lead-out portion 32b forms an ink lead-out port 32c as a liquid passage. The ink contained in the ink bag 32a is led out through the ink lead-out port 32c.

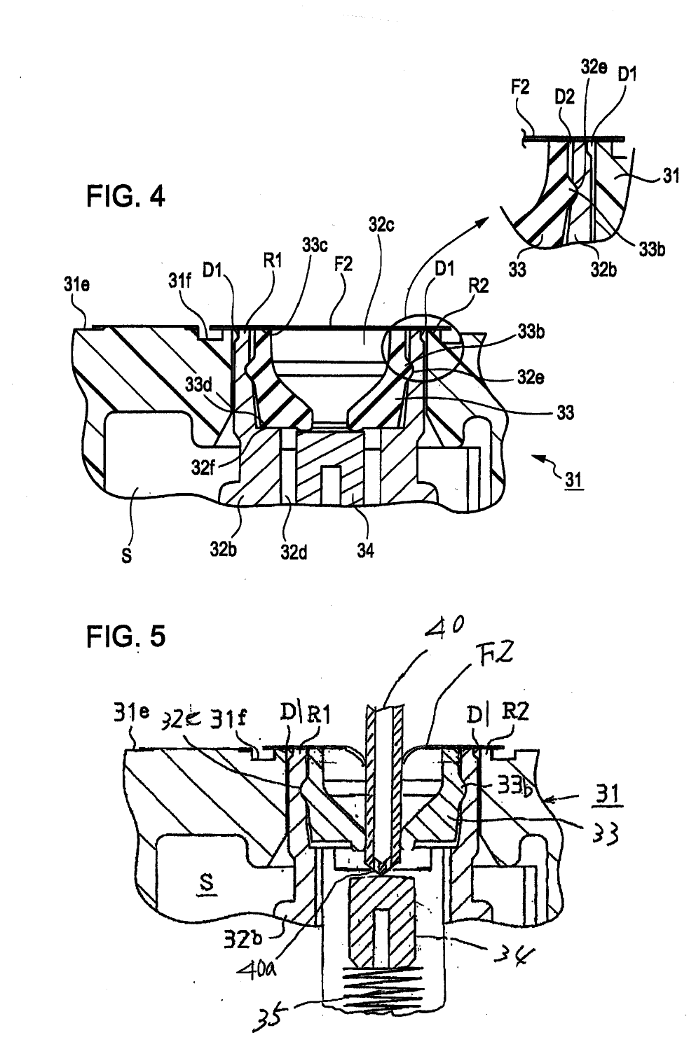

A valve mechanism which is disposed inside the sealing member 33 to close the ink lead-out port 32c and is opened only upon supplying ink is provided in the ink lead-out port 32c as a part of a liquid passage, and is configured so as not to leak the ink contained in the ink bag 32a. The valve mechanism provided in the ink lead-out port 32c includes a valve member 34 which is movably disposed so as to come in contact with the sealing member 33 in the ink lead-out port 32c and in the more inside than the sealing member 33, and a coil spring 35 as an urging member which urges the valve member 34 to come in contact with the sealing member 33. The coil spring 35 urges the valve member 34 to the sealing member 33. In this way, the valve member 34 closes a supply port 33a of the sealing member 33, as shown in FIG. 4. Moreover, the supply port 33a is covered with a sealing film F2. The sealing film F2 will be described in detail below.

When the ink cartridges 23 are arranged in the cartridge holder 12a, an ink supply needle 40 as a liquid lead-out member formed in the liquid ejecting apparatus is inserted into a notch portion C, which is described below, of the sealing film F2 and the ink lead-out port 32b. Moreover, the ink supply needle 40 presses the valve member 34 toward the ink bag 32a against an elastic force of the coil spring 35 (see FIG. 5). When the valve member 34 is separated from the sealing member 33, the ink contained in the ink bag 32a flows out from a gap between the sealing member 33 and the valve member 34 through a plurality of holes 40a formed in the front end of the ink supply needle 40.

That is, before the ink supply needle 40 is inserted, the sealing member 33 comes in contact with the valve member 34 to serves as a valve sheet member for blocking the ink lead-out port 32c. Accordingly, even when the notch portion C is formed in the sealing film F2, the ink does not leak from the notch portion C. In addition, when the ink supply needle 40 is inserted, the ink supply needle 40 separates the valve member 34 from the sealing member 33 against the urging force of the coil spring 35 to open the ink lead-out port 32c.

As shown in FIG. 3, the main case 31a is constituted by an outer case 31c and an inner case 31d and formed of, for example, polyprophylene or polyethylene. The outer case 31c is formed in a substantially rectangular box shape of which the upper surface is opened. The inner case 31d is slightly smaller than the outer case 31c and has a similar shape with that of the ink pack 32. In addition, the inner case 31d restricts movement of the ink pack 32 as the ink case 31 is moved. The upper case 31b is formed in a substantially rectangular plate shape for covering the upper portion of the main case 31a and is formed of, for example, polyprophylene. The upper case 31b has locking pieces K1 at predetermined portions. In addition, when the upper surface of the main case 31a is covered, the locking pieces K1 are configured so as to be engaged with engagement portions K2 formed between the outer case 31c and the inner case 31d.

A supply port mounting portion 31f having a square shape is formed in the middle of a front surface 31e of the main case 31a. An opening 31g communicating with the inner case 31d is formed in the supply port mounting portion 31f. A circular protrusion portion R2 is formed so as to protrude along the edge of the opening 31g toward the outside of the ink case 31. In addition, at four corners of the supply port mounting portion 31f, individual protrusion portions R3 each having a cylindrical shape protrude toward the outside of the ink case 31 as much as the circular protrusion portion R2 protrudes.

A pressurizing port H is formed in one side of the supply port mounting portion 31f. The pressurizing port H communicates with the outside of the main case 31a and the inside of the inner case 31d.

When received in the ink case 31, the ink pack 32 is received in the inner case 31d so that the ink lead-out portion 32b of the ink pack 32 is exposed from the inside of the opening 31g to the outside thereof. As shown in FIG. 5, the ink lead-out portion 32b exposed from the opening 31g is received so that a front end R1 of the ink lead-out portion 32b is positioned at the circular protrusion portion R2.

When the ink pack 32 is received in the inner case 31d, a sealing film F1 (see FIG. 3) made of, for example, polyprophylene or polyethylene is thermally welded in the inner case 31d.

### Sealing Structure

The sealing member 33 disposed inside the ink lead-out port 32c of the ink lead-out portion 32b is formed of an elastic material such as a thermoplastic elastomer. The sealing member 33 is a substantially cylindrical elastic ring of which the upper and lower sides are open. As described in FIGS. 4 and 5, the supply port 33a having a funnel-like shape is formed inside the sealing member 33, thereby elastically sealing an outer circumference of the liquid supply needle 40. A liquid introducing port of the ink supply needle 40 inserted into the supply port 33a is positioned inside a liquid passage 32d of the ink lead-out portion 32b to supply the ink contained in the ink bag 32a to the liquid ejecting apparatus.

A concave portion 32e is formed on a side surface 32g of the inner wall which forms the ink lead-out port 32c of the ink lead-out portion 32b. A convex portion 33b which comes in contact with the concave portion 32e is formed on an outer circumferential surface 33e of the sealing member 33. In the present embodiment, the sealing member 33 is positioned so that the outer surfaces 33e and 33d of the sealing member 33 come in contact with an inner walls 32g and 32f, respectively, which form the ink lead-out port 32c of the ink lead-out portion 32b. That is, the sealing member 33 is positioned by bring the surface 33d opposite the a surface 33c coming in contact with the sealing film F2 of the sealing member 33 into contact with the inner wall 32f forming the ink lead-out port 32c of the ink lead-out portion 32 in an insertion direction of the ink supply needle 40. On the other hand, the sealing member 33 is positioned by bring the convex portion 33b formed on the outer circumferential surface 33e of the sealing member 33 into contact with the concave portion 32e formed on the inner walls 32g of the ink lead-out port 32c in a plane direction perpendicular to the insertion direction of the ink supply needle 40.

In the present embodiment, the sealing film F2 is thermally welded to the supply port mounting portion 31f of the ink case 31. Specifically, the sealing member F2 is thermally welded to the circular protrusion portion R2 which is formed on the opening end surface of the opening 31g protruding outward from the supply port mounting portion 31f, the front end R1 of the ink lead-out portion 32b, and the opening end surface of the sealing member 33. In addition, the sealing member F2 is also thermally welded to each of the individual protrusion portions R3 (see FIG. 3).

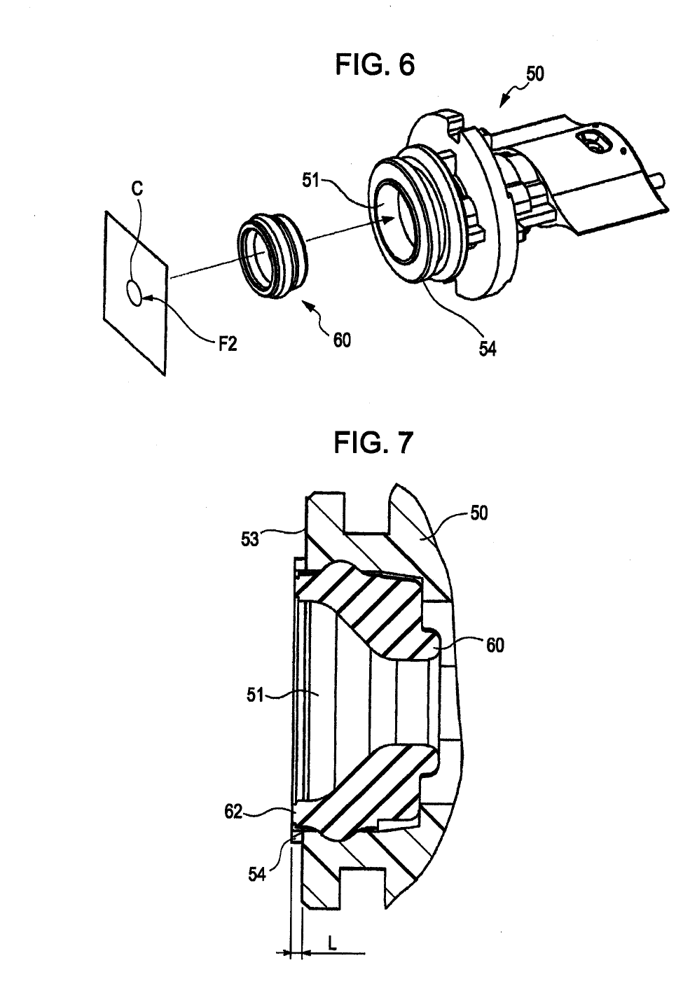

Moreover, in order to enable the ink supply needle 40 to pass, the notch portion C having a cross, which is notched, for example, in four radial directions from the center point, is formed, as shown in FIG. 3. The notch portion C is not limited to the notches, but may be a hole shown in FIG. 6 (according to second embodiment). In particular, it is preferable that the notch portion C has a size so as not to generate a new crack in the sealing film F2 when the ink supply needle 40 is passed. That is, it is preferable that the notch portion C has a notched size enough to pass the largest diameter of the ink supply needle 40. Accordingly, when the ink supply needle 40 is passed, an excessive pressure is not generated in the thermally welded portions and the thermally welded portions can be sufficiently sealed.

In this way, when the notch portion C is formed in the sealing film F2, the ink supply needle 40 can be smoothly inserted into the inside of the ink lead-out portion 32b through the notch portion C of the sealing film F2, as shown in FIG. 4.

Moreover, as shown in FIG. 5, the ink supply needle 40 according to the first embodiment has a sharp front end, thereby easily tearing the sealing film F2.

Comparing with a sealing film F2 having no the notch portion C, the sealing film F2 according to the first embodiment is not drawn by the ink supply needle 40, thereby maintaining a sealing property without excessive load imposed on the thermally welded portions. However, if the sealing film F2 is drawn by the ink supply needle 40, a part of the sealing film 2 in FIG. 4 may be inserted between the sealing member 33 and the ink supply needle 40 at the worst. In this case, ink may leak from the portion into which the sealing film F2 is inserted. In the present embodiment, it is possible to prevent a problem such as bending beforehand.

The notch portion C of the sealing film F2 may be a hole or a notch smaller than the largest diameter into which the ink supply needle 40 is inserted. However, as for a sealing film having no the notch portion C, an excessive pressure is imposed on the thermally welded portions during tearing of the ink supply needle 40 and the sealing film is even drawn by an excessive force for the while. However, even though the sealing film F2 having the slightly formed notch portion C is torn and the notch portion C becomes larger due to the ink supply needle 40, the pressure imposed on the thermally welded portions is small and the torn portion of the sealing film F2 becomes smaller.

Since butyl rubber, which is a material of a known sealing member, has no a common characteristic with a material of the ink case 31 and the ink lead-out portion 32b, the known sealing member cannot be thermally welded to the sealing film F2, the ink case 31, and the ink lead-out portion 32b, regardless of a material of the sealing film F2.

The above-described welding is possible since the material of the seal member 33 can be selected. As the thermoplastic elastomer which is the material of the seal member 33, a trade name MNCS (JP-A 2002-225303) made by Bridgestone Corporation can be exemplified. The inventors have carried out an experiment and found that the sealing member 33 formed of this material was thermally welded satisfactorily using polyprophylene (PP), erythropoietin (EPO), polyethylene (PE), and the like of a polyolefin series.

In the present embodiment, it is preferable that a material of the ink lead-out portion 32b is the same as that of the ink bag 32a since the ink lead-out portion 32b is thermally welded with the ink bag 32a. Accordingly, in the present embodiment, the materials of the ink bag 32a, the ink lead-out portion 32b, and the ink case 31 are all polyprophylene, polyethylene, or the like. IF the sealing film F2 is also formed of polyprophylene, polyethylene, or the like, the above-described welding can be embodied.

Accordingly, when the sealing film F2 is thermally welded to the circular protrusion portion R2, the front end portion R1, and the sealing member 33, a gap D1 between the opening 31g and the ink lead-out portion 32b and a gap D2 between the ink lead-out portion 32b and the sealing member 33 are also sealed by the sealing film F2.

Since the gap D2 is sealed by the sealing film F2, the concave portion 32e of the ink lead-out portion 32b and the convex portion 33b of the sealing member 33 just serve as positioning the sealing member 33 and may not be required to block a liquid. Accordingly, the convex portion 33b of the sealing member 33 and the concave portion 32e of the ink lead-out portion 32b are not necessary elements. That is, one or both of the inner wall 32g forming the ink lead-out port 32c of the ink lead-out portion 32b and the outer circumferential surface 33e of the sealing member 33 may be configured so as to be flat.

The following excellent advantages can be obtained by sealing the gap D2 by use of the sealing film F2. For example, even though the concave portion 32e and the convex portion 33b are sealed defectively due to deterioration of roundness of the ink lead-out portion 32b, ink leakage from the gap D2 is not generated. Moreover, even though the concave portion 32e and the convex portion 33b are not sealed due to the pressure application to the ink from the ink bag 32a, it is possible to prevent the ink leakage owing to the sealing film F2. Furthermore, even though the ink cartridges 23 fall or vibrates, it is possible to prevent the ink leakage owing to the sealing film F2.

On the other the hand, the following excellent advantages can be obtained by sealing the gap D1 by use of the sealing film F2.

The inner case 31d receiving the ink pack 32 and a space S (see FIG. 3) formed by the sealing film F1 are in an airtight state other than the pressurizing port H. Accordingly, the air supplied from the pressurizing port H to the inner case 31d by the pressurizing pump 25 (see FIG. 1) applies the pressure to the ink pack 32 received in the space S since the inner case 31d are maintained air-tightly.

Since the sealing film F2 is thermally welded to the front end R1 of the ink lead-out portion 32b, the ink lead-out port 32c of the ink lead-out portion 32b is also sealed, thereby blocking the inside of ink pack 32 from the outside. In addition, since the ink lead-out port 32c of the ink lead-out portion 32b is sealed by thermally welding the sealing film F2 to the circular protrusion portion R2, the ink supply needle 40 is inserted from the outside and the valve member 34 is opened. Accordingly, a problem that bubbles are entered into the ink pack 32 does not arise. Moreover, since the sealing film F2 is thermally welded to the four individual protrusion portions R3 surrounding the circular protrusion portion R2, it is possible to prevent the sealing film F2 from being peeled off from the circular protrusion portion R2 due to any force.

Two ink lead-out portion fixing ribs 31j are formed in a form of inserting the ink lead-out portion 32b. End portions 31j1 of the ink lead-out portion fixing ribs 31j come in contact with a circular protrusion portion 32b1 having in a disk-like shape formed in the outer circumference of the ink lead-out portion 32b, so as to be fixed to the main case 31a. With such a configuration, when the thermal welding is performed, it is possible to prevent the ink lead-out portion 32b from being moved into the main case 31a.

A rotation preventing member 31k is a protrusion engaged with a concave portion (not shown) formed in the circular protrusion portion 32b1 of the ink lead-out portion 32b. The rotation preventing member 31k suppresses movement in a rotation direction of the ink pack 32 to position the ink pack 32 at a predetermined position.

### Operation of Liquid Ejecting Apparatus

Next, an operation a printer 11 having the above-described configuration will be described when the printer 11 performs supplying of ink and printing.

As shown in FIG. 1, the ink cartridges 23 of respective colors are set in the cartridge holder 12a by sliding the ink cartridges 23 toward the inside of the cartridge holder 12a in the sub-scanning direction. When each of the ink cartridges 23 is set, the ink supply needle 40 supplied in the cartridge holder 12a is inserted smoothly through the notch portion C (see FIG. 3 or 6) of the sealing film F2 to be connected to the ink lead-out portion 32b (see FIG. 4). The ink supply needle 40 is connected to the valve unit 21 with an ink supply tube 36 interposed therebetween. Accordingly, the ink contained in the ink pack 32 is supplied to the valve unit 21, and is supplied to the printing head 20 in a state where a pressure is adjusted.

Simultaneously, an air introducing member provided in the cartridge holder 12a is connected to the pressurizing port H of each of the ink cartridges 23 (the main case 31a). The air introducing member is connected to the pressuring pump 25 with the ink introducing tube interposed therebetween. Accordingly, pressuring air can be introduced into the space S for receiving the ink pack 32 by the pressuring pump 25. At this time, an opening of the inner case 31d is air-tightly sealed by the sealing film F1. The gaps D1 and D2 shown in FIG. 4 are air-tightly sealed by the sealing film F2. Accordingly, the air introduced into the inner case 31d through the pressurizing port H does not leak to the outside and the ink does not also leak from the gap D2. As a result, it is possible to precisely control the pressure of the ink pack 32.

In this way, when the ink pack 32 of each of the ink cartridges 23 is pressured by the pressuring air introduced from the pressurizing pump 25, the ink contained in the ink pack 32 is supplied to the valve unit 21. In addition, the pressure the ink temporarily stored in the valve unit 21 is adjusted, and the ink is supplied to the printing head 20.

Subsequently, the carriage 15 is moved in the main scanning direction while a paper-feeding unit moves a printing medium P in the sub-scanning direction. At this time, on the basis of image data, the printing operation can be performed on a printing medium P by ejecting the ink through the printing head 20.

The above-described embodiment may be modified in the following form.

In the present embodiment, when the ink supply needle 40 supplied in the cartridge holder 12a tears the sealing film F2 to be connected to the ink lead-out portion 32b, the cross shape, the X like shape, or the like is notched in the sealing film F2 so as to tear the sealing film F2. However, the notch portion C may be formed in any shape as long as the ink supply needle 40 can be easily inserted. For example, the notch portion C may be notched in a character form extending radially from the center portion thereof in two directions, or from the center portion thereof in three or more directions. The shape of the hole may not be limited to the circle, but may be any shape of a polygon such as a triangle or a square or a star.

In the above-described embodiment, one circular protrusion portion R2 is formed in the front surface 31e of the ink case 31. However, two or more circular protrusion portion may be formed. With such a configuration, it is possible to thermally weld the sealing film F2 more reliably.

In the present embodiment, the ink case 31, the sealing member 33, and the sealing film F2 are formed of polyprophylene, but may be formed of any material which can be thermally welded. For example, they may be formed of polyethylene.

In the present embodiment, the square sealing film F2 has the same size as that of the supply port mounting portion 31f, but may has any shape and any size as long as it can block the gaps D1 and D2. For example, the diameter of the sealing film F2 may be formed in the circular shape so as to have the same length as that of one side of the supply port mounting portion 31f, or in a circular shape so as to cover the gaps D1 and D2.

In the present embodiment, six ink cartridges 23 are provided, but the number of the ink cartridges mounted in the printer 11 is not limited.

### Second Embodiment

FIG. 6 is an exploded perspective view illustrating an ink lead-out portion 50 different from that according to the first embodiment. As shown in FIG. 6, the ink lead-out portion 50 has the outer shape different from that of the ink lead-out portion 32b according to the first embodiment. Moreover, in the present embodiment, the sealing film F2 having the notch portion C is not thermally welded to the ink case, but thermally welded only to an ink lead-out port 50 and a sealing member 60. Such a configuration according to the second embodiment is different from that according to the first embodiment, and the other configuration is the same as that according to the first embodiment. Moreover, a notch portion C shown in FIG. 6 may be a notch like the first embodiment as shown in FIG. 3.

FIG. 7 is a partial sectional view illustrating a case where the sealing member 60 is inserted into the ink lead-out port 51 and the sealing film F2 is not thermally welded.

The ink lead-out portion 50 has a first circular welding portion 54 protruding more than a opening end surface 53 by a height L. Similarly, the sealing member 60 has a second circular welding portion 62 protruding from the opening end surface 53 of the ink lead-out portion 50 by a height L when the sealing member 60 is inserted into the ink lead-out port 51. That is, the first welding portion 54 and the second welding portion 62 form one surface.

After a configuration shown in FIG. 7 is set, the sealing film F2 is attached to the first welding portion 54 and the second welding portion 62, and the sealing film F2 is thermally welded by heat and pressure. At this time, the first welding portion 54 and the second welding portion 62 are melted and thermally welded simultaneously so as to be incorporated with the melted sealing film F2. After welded, the sealing film F2 is supported to a surface which is flush with the opening end surface 53 since the first welding portion 54 and the second welding portion 62 are melted.

Since the first welding portion 54 and the second welding portion 62 protrude in a circular shape, so that the melted portions are limited. Accordingly, it is possible to perform the thermal welding operation under a relatively small pressure and for a relatively small period of time. Moreover, since the thermal welding operation is performed until the first welding portion 54 and the second welding portion 62, it is possible to complete the thermal welding operation, thereby reducing a thermal welding failure.

In the present embodiment, a portion corresponding to the gap D2 shown in FIG. 4. Accordingly, it is possible to prevent the ink from leaking similarly to the first embodiment. Therefore, the advantage obtained by sealing the gap D1 cannot be obtained in the present embodiment, but the other advantages according to the first embodiment can be obtained. Any modification of the first embodiment can be applied to the present embodiment except that it is not necessary to cover or shield the gap D1. Moreover, the first welding portion 54 and the second welding portion 62 shown in FIG. 7 may be also applied to the first embodiment.

### Third Embodiment

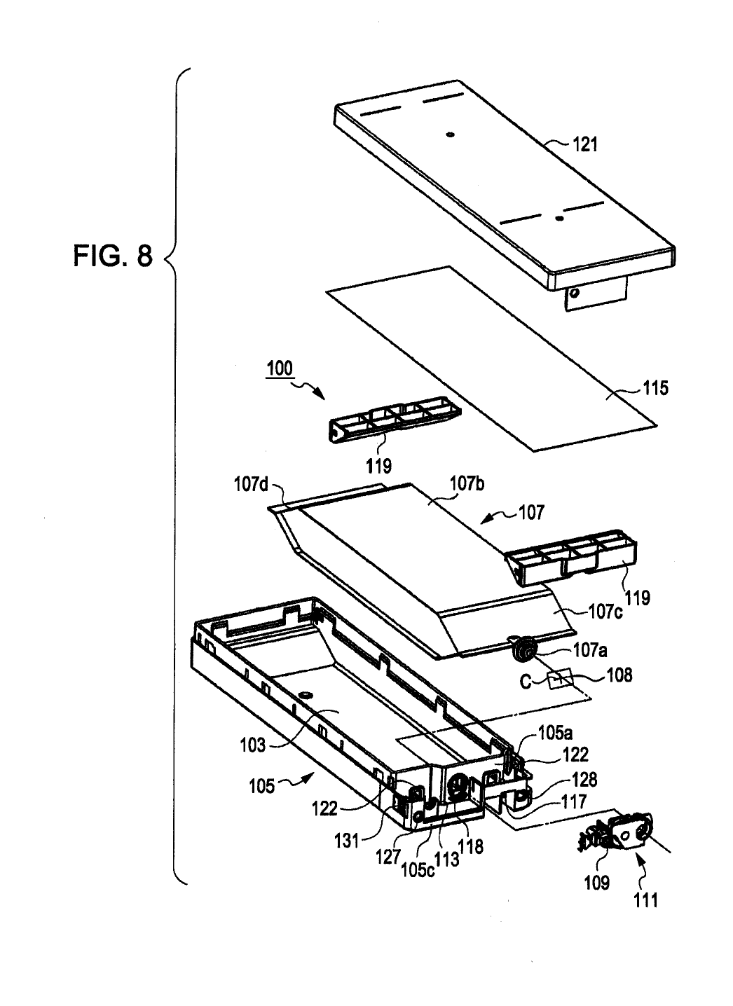

A third embodiment will be described with reference to FIGS. 8 to 15B. A configuration of an ink cartridge as a liquid container according to the present embodiment is different from that according to the first embodiment. The ink cartridge according to the present invention can be mounted in the same liquid ejecting apparatus as that described in the first embodiment. Accordingly, a detailed description of the liquid ejecting apparatus is omitted.

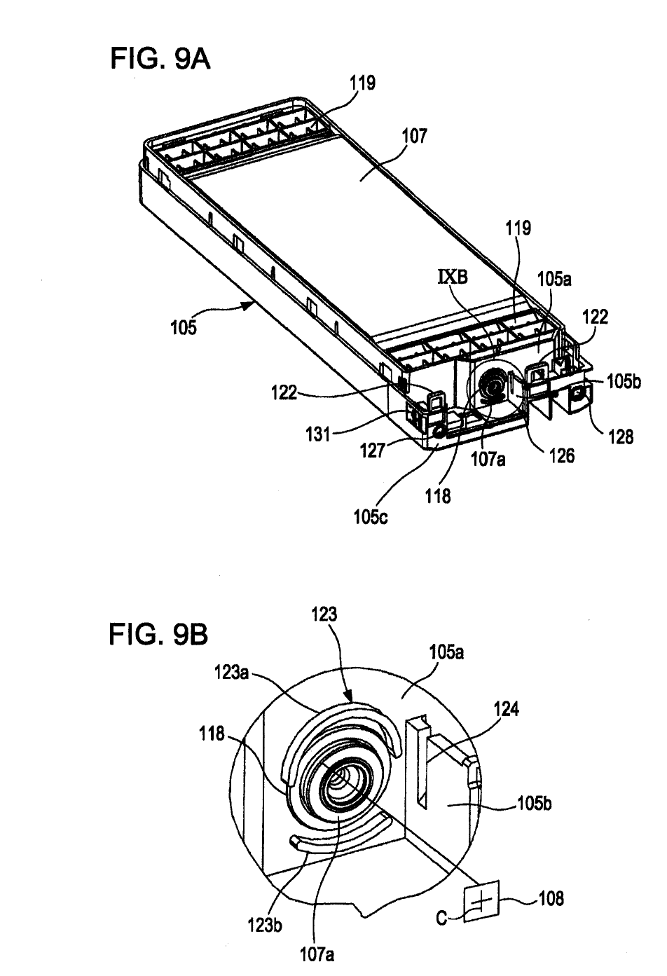

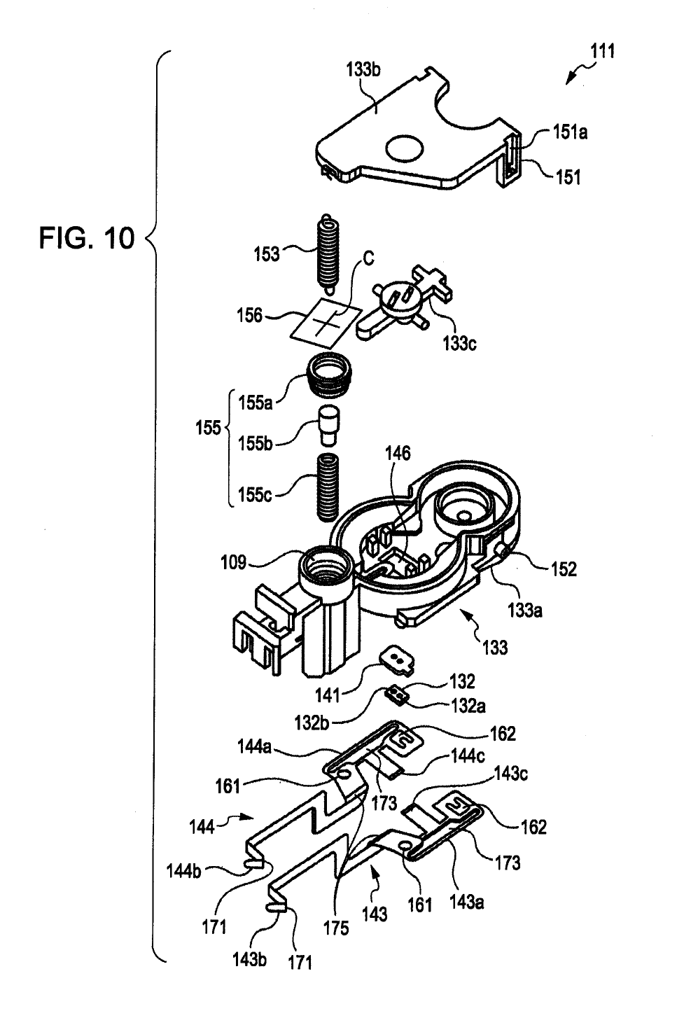

FIG. 8 is an exploded perspective view illustrating the ink cartridge as the liquid container according to a third embodiment. FIG. 9A is a perspective view illustrating an ink pack as the liquid container and a spacer for filling gaps around the ink pack in a bag member receiving portion of the container body shown in FIG. 8. FIG. 9B is an enlarged view illustrating an IXB portion shown in FIG. 9A. FIG. 10 is an exploded perspective view illustrating a liquid level detecting unit shown in FIG. 8.

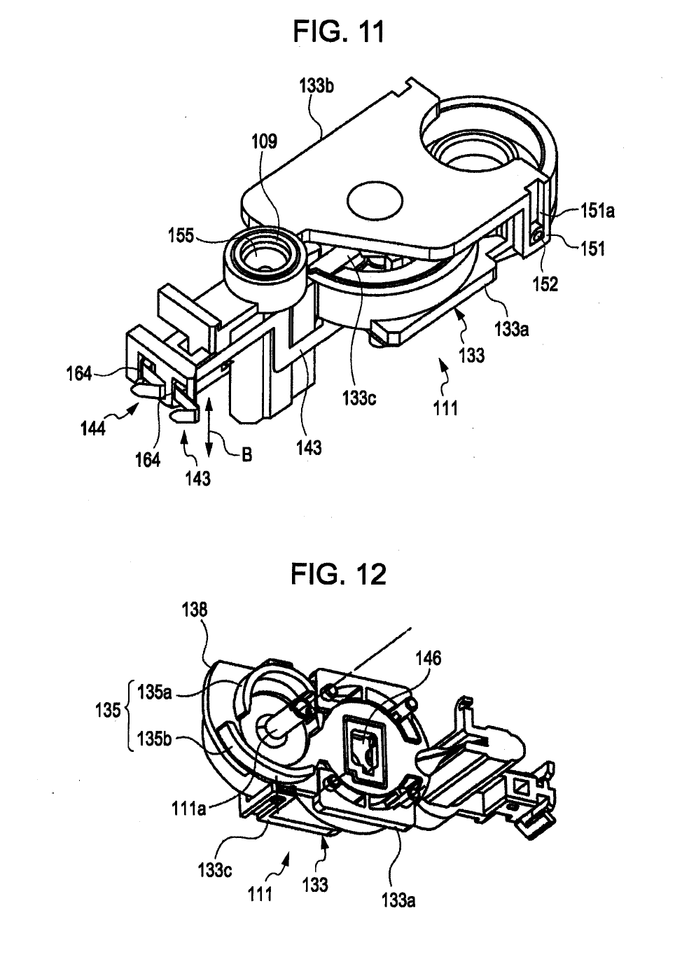

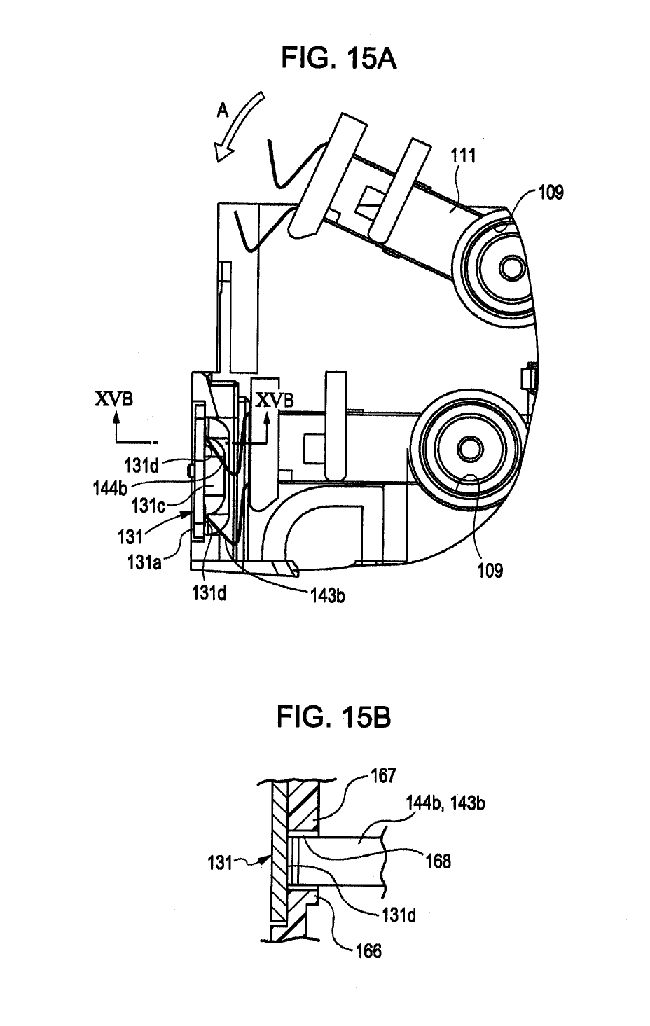

FIG. 11 is a perspective view illustrating the assembled liquid level detecting unit. FIG. 12 is a perspective view illustrating the fitted liquid level detecting unit. FIG. 15A is a partially enlarged view illustrating a circuit board and the periphery thereof. FIG. 15B is a sectional view illustrating the circuit board taken along XVB-XVB.

An ink cartridge 100 shown in FIG. 8 is detachably mounted in a cartridge mounting portion of a commercial ink jet type printing apparatus to supply ink to a printing head (liquid ejecting head) mounted in the printing apparatus.

The ink cartridge 100 includes a container body 105 which partitions a bag member receiving portion 103 pressurized by a pressuring member; an ink pack 107 as a liquid containing portion which contains ink, is received in the bag member receiving portion 103, and ejects the stored ink from an ink lead-out portion (liquid lead-out portion) 107a by pressurization of the bag member receiving portion 103; and a liquid level detecting unit 111 which has a liquid lead-out member 109 supplying the ink to a printing head as an external liquid consuming apparatus and is detachably mounted in the container body 105.

The container body 105 is a case formed by resin molding. The substantially box-like bag member receiving portion 103 having an open upper portion and a detecting-unit receiving portion 113 being disposed in the front surface of the bag member receiving portion 103 and receiving the liquid level detecting unit 111 are partitioned in the container body 105.

The open upper portion of the bag member receiving portion 103 is sealed by a sealing film 115 after the ink pack 107 is received. In this way, the bag member receiving portion 103 is air-tightly sealed.

On a partition wall 105a partitioning the bag member receiving portion 103 and the detecting-unit receiving portion 113, a pressurizing port 117 as a communication passage for transmitting pressurizing air to the bag member receiving portion 103 formed in a sealing chamber by a sealing film 115 is disposed. When the ink cartridge 100 is mounted in the cartridge mounting portion of the ink jet type printing apparatus, a pressurizing air supply member close to the cartridge mounting portion is connected to the pressurizing port 117 to pressurize the ink pack 107 by use of the pressurizing air supplied to the bag member receiving portion 103.

The ink pack 107 is formed by connecting a cylindrical ink lead-out portion 107a, into which a connection needle 111a (see FIG. 12) of the liquid level detecting unit 111 is inserted, to one end of a flexible bag member 107b formed by a multi-layer sealing film.

The ink lead-out portion 107a of the ink pack 107 is air-tightly inserted into an opening 118 for a connection port insertion formed in the partition wall 105a, so that the front end thereof protrudes inside the detecting-unit receiving portion 113, as shown in FIGS. 9A and 9B. In addition, since the ink lead-out member 107a has the same configuration as that of the ink lead-out portion 50 (see FIGS. 6 and 7) according to the second embodiment, the detailed description is omitted.

Here, as shown in FIGS. 8, 9B, and 10, a sealing film 108 having the notch portion C is also thermally welded to the ink lead-out portion 107a in the same manner according the above-described second embodiment. The sealing film 108 is thermally welded to an opening end surface of the ink lead-out portion 107a and a sealing member (not shown) disposed in the ink lead-out portion 107a in the same manner shown in FIGS. 6 and 7. With such a configuration, it is possible to obtain the same advantage as that according to the second embodiment. Moreover, since the sealing film 108 is the same as the sealing film F2 used in the first and second embodiments, the detailed description is omitted. The notch portion C formed in the sealing film 108 may not be a notch as shown in FIG. 8, but the notch portion C may be a hole shown in FIG. 6 like the first embodiment.

Before connecting the liquid level detecting unit 111, ink adjusted so as to have high deaeration is filled in the ink pack 107, and then the ink pack 107 is sealed with the sealing film 108.

When the ink pack 107 is mounted in the bag member receiving portion 103, spacers 119 made of a resin material are mounted above inclination portions 107c and 107d formed in the front and rear portions of the flexible bag member 107b. When the upper surface of the bag member receiving portion 103 is covered with the sealing film 115, the spacers 119 made of the resin material prevent the ink pack 107 from moving in the inside of the sealing chamber and fill empty spaces of the sealing chamber. Accordingly, it is possible to improve pressurization efficiency when the inside of the bag member receiving portion 103 is pressurized by a pressurizing air.

A cover 121 made of the resin material is mounted on the detecting-unit receiving portion 113 and the sealing film 115. When the container body 105 is covered with the cover 121, engagement member (not shown) are engaged with engagement portions 122 of the container body 105 to be fixed to the container body 105.

As shown in FIG. 9B, a mounting portion 123 mounted with the liquid level detecting unit 111 by a predetermined operation is formed around an opening 118 opened on the partition wall 105a.

In the present embodiment, the mounting portion 123 has a fitting structure in which the liquid level detecting unit 111 is rotatably fitted and is formed in a position away from a circuit board 131, which is described below, on the container body 105. Specifically, the mounting portion 123 has two curved convex walls 123a and 123b. The convex walls 123a and 123b form a circular configuration for suppressing rotation of the liquid level detecting unit 111.

In a position close to the mounting portion 123, as shown in FIG. 9B, a locking groove 124 which prevents separation of the liquid level detecting unit 111 fitted to the mounting portion 123 is formed in the partition wall 105 erected from the detecting-unit receiving portion 113 and perpendicular to the partition wall 105a.

In order to mount the liquid level detecting unit 111, an opening 126 notched in a position opposite the mounting portion 123 is formed on a front surface wall 105c of the container body 105, which is a partition wall for covering the front surface of the detecting-unit receiving portion 113.

As shown in FIG. 9A, in both sides of the front surface wall 105c, there are formed positioning holes 127 and 128 into which positioning pins formed in the cartridge mounting portion are inserted upon mounting the ink cartridge 100 in the cartridge mounting portion.

On a side wall of the container body 105 close to the positioning hole 127, the circuit board 131 which is electrically connected to a connection terminal provided in the cartridge mounting portion upon mounting the ink cartridge 100 in the cartridge mounting portion is formed in a position close to the front surface wall. A plurality of contact points connected to the connection terminal provided in the cartridge mounting portion are formed in the circuit board 131.

On the rear surface of the circuit board 131, as shown in FIGS. 15A and 15B, a memory element 131 for recording information such as a remaining ink or a use history of the cartridge is mounted and contact points 131d for conductively connecting a sensor member 132 (hereinafter, referred to as “a sensor member” in addition to a piezoelectric element) (see FIG. 10) to a connection terminal of the ink jet type printing apparatus is formed. Accordingly, when the ink cartridge 100 (see FIG. 8) is mounted in the cartridge mounting portion of the printing apparatus and each contact point (not shown) on the surface of the circuit board 131, the memory element 131c or the sensor member 132 is electrically connected to a control circuit of the printing apparatus with the circuit board 131 interposed therebetween. In this way, it is possible to control an operation of the memory element 131c or the sensor member 132 from the printing apparatus.

According to the present embodiment, as shown in FIGS. 10 and 11, the liquid level detecting unit 111 includes a resin unit case 133 which is mounted in the container body 105 (see FIG. 8) by a rotation operation, the sensor member 132 which is fixed to the rear surface of the unit case 133 with a sensor base 141 interposed therebetween, an insulating sensor sealing film (not shown) which covers the surface of the sensor base 141 around the sensor member 132, and a pair of metal plate relay terminals 143 and 144 which are mounted on the unit case 133 from the upside of the sensor sealing film (not shown) in order to connect terminals 132a and 132b of the sensor member 132 to the contact points 131d (see FIGS. 15A and 15B) of the rear surface of the circuit board 131 (see FIGS. 15A and 15B).

The unit case 133 includes an ink lead-out portion 109 into which an ink supply needle (liquid lead-out needle) of the cartridge mounting portion, a case body 133a which has an inner flow space 146 communicating with the ink lead-out portion 109, a flow passage forming member 133c which is mounted inside the inner flow space 146 to form a flow passage communicating with the ink lead-out portion 109 in cooperation with the inner flow space 156, a pressure chamber sealing film (not shown) which is thermally welded on the end surface of the case body 133a, and a cover 133b which covers the pressure chamber sealing film to protect it.

The cover 133b is rotatably connected to the case body 133a by fitting an engagement shaft 152 protruding from the outer circumference of the case body 133a to a hole 151a of a locking piece 151 protruding on the base end thereof. Moreover, the cover 133b is fixed to the case body 133a by connecting the front end thereof to the case body 133a using a spring 153.

When the ink supply needle of the cartridge mounting portion is inserted, a flow passage closing mechanism 155 is mounted in the ink lead-out portion 109. The flow passage closing mechanism 155 includes a cylindrical sealing member 155a fixed to the ink lead-out portion 109 and a valve mechanism disposed inside the sealing member 155a to close a liquid passage. The valve mechanism includes a valve member 155b which is seated to the sealing member 155a to close the flow passage and a spring member 155c which urges the valve member 155b in a direction in which the valve member 155b is seated to the sealing member 155a. Moreover, since the ink lead-out portion 109 has the same as that of the ink lead-out portion 50 (see FIGS. 6 and 7) according to the second embodiment, the detailed description is omitted.

An opening end of the ink lead-out portion 109 mounted with the flow passage closing mechanism 155 is sealed by a sealing film 156 having a notch portion C (see FIG. 10). The sealing film 156 is thermally welded to an opening end surface of the ink lead-out portion 109 and an end surface of the sealing member 155a mounted in the ink lead-out portion 109 in the same manner as that according to the second embodiment (see FIGS. 6 and 7). Since the sealing film 156 also forms an ink passage in the ink lead-out portion 109 provided in the liquid level detecting unit 111, the problem to be solved in the ink lead-out portion 107a directly connected to the ink pack 107 is the same. In the present embodiment, it is possible to also solve the problem that the ink leaks from the gap D2 described in FIG. 4 in the ink lead-out portion 109 provided in the liquid level detecting unit 111. Moreover, since the sealing film 156 has the notch portion C like the sealing films F2 and 108 used in the first and second embodiments, the detailed description is omitted.

When the ink cartridge 100 is mounted on the cartridge mounting portion of the printing apparatus, the ink supply needle mounted in the cartridge mounting portion is inserted into the liquid lead-out portion 109 through the notch portion C of the sealing film 156. At this time, a flow passage inside the unit case 133 communicates with the ink supply needle by separating the valve member 155b from the sealing member 155a by the ink supply needle which has been inserted into the liquid lead-out portion 109, so that the ink can be supplied to the printing apparatus.

As shown in FIG. 12, in a position corresponding to the mounting portion 123 (see FIG. 9A) of the container body 105, the case body 133a has a container fitting portion 135 rotatably fitted to the mounting portion 123 in the rear surface thereof. The connection needle 111a inserted so as to be inserted into the ink lead-out portion 107a of the ink pack 107 is disposed inside the container fitting portion 135. The connection needle 111a is inserted into the ink lead-out portion 107a through the sealing film 108 having the notch portion C shown in FIGS. 8 and 9B. In this way, the valve mechanism inside the ink lead-out portion 107a is opened so as to lead out the ink. That is, the connection needle 111a serves as the liquid lead-out member like the above-described ink supply needle 40. The flow passage formed by the above-described inner flow space 146 and the flow passage forming member 133b (see FIGS. 10 and 11) is an inner flow passage communicating with the ink lead-out portion 109 to the connection needle 111a.

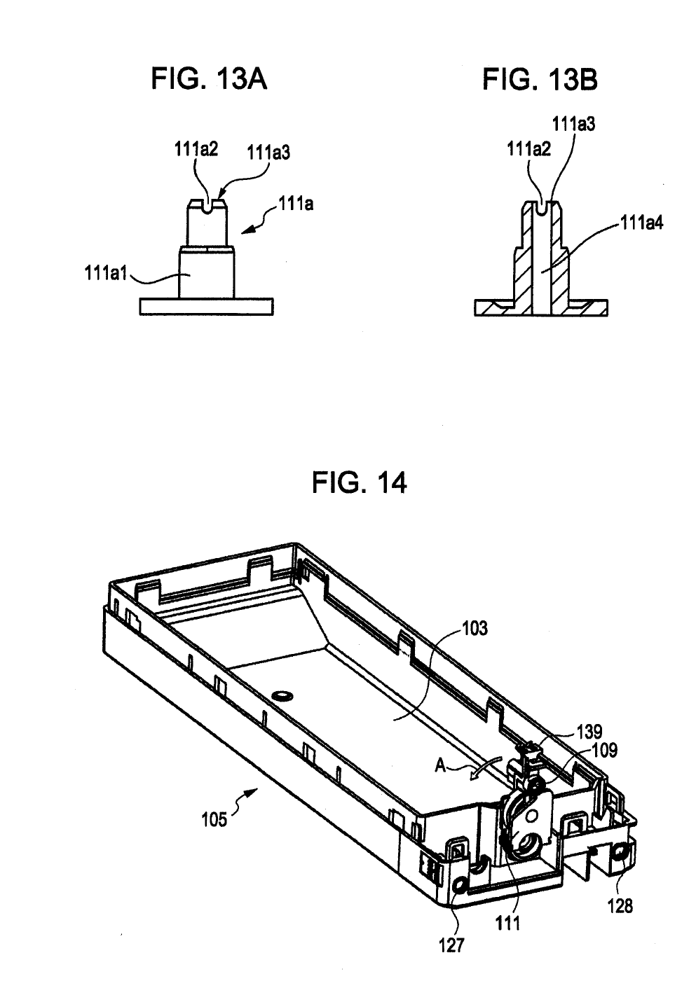

As shown in FIGS. 13A and 13B, the ink lead-out member 111a disposed in the liquid level detecting unit 111 includes a cylindrical body 111a1 through which a flow passage 111a4 is formed and a slit 111a2 which is formed from an insertion end surface of the cylindrical body toward a circumferential wall of the cylindrical body to communicate with the flow passage 111a4. In addition, the insertion end surface of the cylindrical body is a flat surface 111a3. That is, the front end surface of the ink lead-out member 111a disposed in the liquid level detecting unit 111 is not sharp unlike the ink lead-out needle 40 shown in FIG. 5. However, since the notch portion C is formed in the sealing film 108, the ink lead-out member 111a passes through the notch portion C to be easily inserted.

The sensor member 132, which serves as a piezoelectric sensor fixed to the rear surface of the case body 133a so as to apply vibration to the inner flow passage, outputs as an electrical signal variation in residual vibration varied in accordance with ink mass flow (pressure) of the inner flow passage. A control circuit of the printing apparatus analyzes the output signal of the sensor member 132 to detect an amount of ink remained in the ink pack 107.

In the present embodiment, as shown in FIG. 12, the container fitting portion 135 includes two curved convex walls 123a and 123b rotatably fitted to the convex walls 123a and 123b of the mounting portion 123. The convex walls 135a and 135b form a circular structure for suppressing rotation of the liquid level detecting unit 111.

A locking piece 138 is formed around the container fitting portion 135 of the case body 133a. By rotating the liquid level detecting unit 111 in a direction of an arrow A in a state where the container fitting portion 135 is fitted to the mounting portion 123 (see FIG. 9A) shown in FIG. 14, the locking piece 138 is engaged with the locking groove 124 (see FIG. 9B) to prevent separation of the container fitting portion 135.

As shown in FIGS. 10, 15A, and 15B, the relay terminals 143 and 144 are mounted in the case body 133a of the unit case 133 to electrically connect sensor member 132 to the circuit board 131 so that one ends 143a and 144a thereof are connected to the terminals 132a and 132b of the sensor member 132 assembled in the unit case 133 and the other ends 143b and 144b thereof are connected to the contact points 131d of the circuit board 131.

Specifically, the relay terminals 143 and 144 are fixed to the case body 133a of the unit case 133 in a state where one ends 143a and 144a thereof are conductively connected to the terminals 132a and 132b of the sensor member 132. In addition, the other ends 143b and 144b of the relay terminals 143 and 144 are supported in the unit case 133 so as to move in a direction (a direction of an arrow B in FIG. 11) of a rotation axis when the liquid level detecting unit 111 is mounted in the container body 105.

Contact pieces 143c and 144c to be connected to the terminals 132a and 132b are incorporated to one ends 143a and 144a of the relay terminals 143 and 144. In addition, attachment holes 161 and 162 press-fitted bosses (not shown) protruding from the case body 133a are formed in one ends 143a and 144a of the relay terminals 143 and 144 so as to be fixed to the case body 133a by press-fitting.

As shown in FIG. 11, the position of the other ends 143b and 144b of the relay terminals 143 and 144 is controlled by a slit 164 formed an end of the case body 133a along the direction (the direction of an arrow B in FIG. 11) of the rotation axis when the liquid level detecting unit 111 is mounted in the container body 105. In addition, the other ends 143b and 144b are supported so as to move in the direction of the arrow B in FIG. 11.

As shown in FIG. 15B, a pair of guide ribs 166 and 167, which serve as a position controlling member for aligning the other ends 143b and 144b of the relay terminals 143 and 144 to the contact points 131d of the circuit board 131, protrude near a position in which the circuit board 131 of the container body 105 is mounted. The one pair of guide ribs 166 and 167 form a groove 168 through which the other end 143 and 144b can pass.

As shown in FIG. 10, elastic members 171 which can be elastically deformed to the rotation axis when the liquid level detecting unit 111 is mounted in the container body 105 are formed in the other ends 143b and 144b of the relay terminals 143 and 144. The elastic members 171 are curved portions which are formed when the relay terminals 143 and 144 are formed by press forming. Aperture-shaped portions 173 for improving rigidity of the terminals are formed in a lengthwise direction of the terminals near the attachment holes 161 and 162 of one ends 143a and 144a of the relay terminals 143 and 144. The relay terminals 143 and 144 are formed of a metal plate by press-forming and the aperture-shaped portions 173 are formed by a pressing process.

The ink cartridge 100 according to the present embodiment is assembled in the following sequence.

First, as shown in FIG. 14, the liquid level detecting unit 111 is perpendicularly fitted to the mounting portion 123 of the container body 105. Next, as shown in FIG. 15, the other ends 143b and 144b of the relay terminals 143 and 144 protruding in the other end of the liquid level detecting unit 111 are contacted to the contact points 131d of the rear surface of the circuit board 131 by rotating the fitted liquid level detecting unit 111 in the direction of the arrow A. In this way, the mounting operation of the liquid level detecting unit 111 to the container body 105 is completed.

Subsequently, as shown in FIGS. 8 and 9, when the ink pack 107 is mounted in the bag member receiving portion 103 of the container body 105, the ink lead-out member 111a (see FIG. 12) of the liquid level detecting unit 111 is connected to the ink lead-out portion 107a by passing the ink lead-out member 111a through the notch portion C of the sealing film 108. At this time, even though the insertion end surface of the ink lead-out member 111a has the flat surface 111a3 in FIGS. 13A and 13B, the insertion end surface can smoothly pass through the notch portion C of the sealing film 108. Subsequently, the spacers 119 are set on the inclination portions 107c and 107d of the ink pack 107. Next, the sealing film 115 is adhered to the upper surface of the bag member receiving portion 103 by, for example, a thermal welding operation to air-tightly seal the bag member receiving portion 103, so as to become the sealing chamber. In addition, the cover 121 is mounted on the sealing film 15. In this way, the assembling operation is completed.

When the ink cartridge 100 is mounted in the cartridge mounting portion of the printing apparatus, the ink supply needle (not shown) disposed in the cartridge mounting portion is inserted into the liquid lead-out portion 109 through the notch portion C of the sealing film 156. Accordingly, it is possible to supply the ink from the ink cartridge 100 to the printing head.

According to the present embodiment, it is possible to obtain the same advantage as that according to the second embodiment using the sealing films 108 and 156 having the notch portion C. In addition, like the second embodiment, any modification of the first embodiment can be applied to the present embodiment except that it is not necessary to cover or shield the gap D1.

In the above-described embodiments, as a structure for mounting the liquid level detecting unit 111 in the container body 105, the structure for the rotation operation has been described. However, the mounting structure is not limited to the above-described embodiments as long as the mounting operation is simply performed. For example, a structure for mounting the liquid level detecting unit in the container body by performing a slide operation in a vertical direction may be taken into consideration.

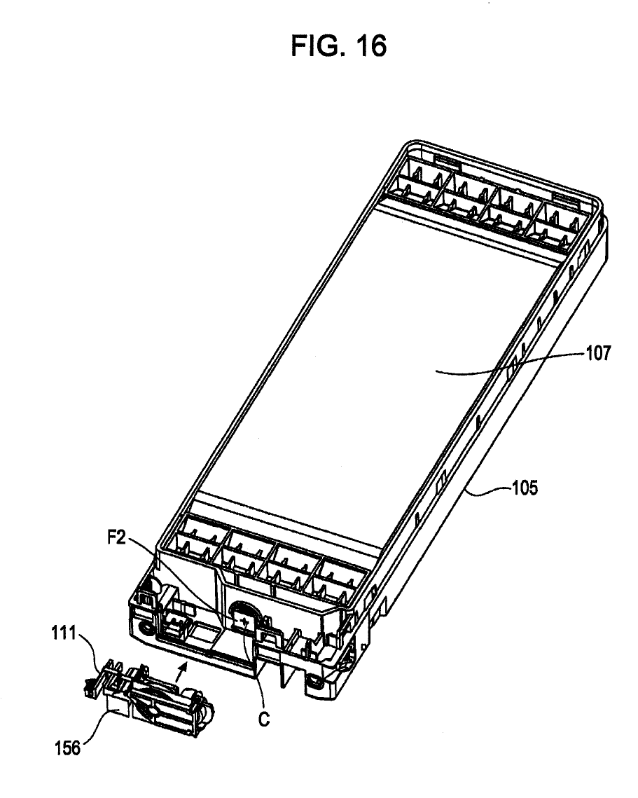

As shown in FIG. 16, the notch portion C may be formed only in the sealing film F2, but the notch portion C may not be formed in the sealing film 156 of the liquid level detecting unit 111. Since the sharp ink lead-out needle disposed in the printer can be inserted into the sealing film 156, it is not necessary to form the notch portion C in the sealing film 156. However, if the notch portion C is formed in the sealing film 156, the ink lead-out needle can be smoothly inserted into the sealing film 156, thereby reliably preventing the sealing film 156 from being drawn.

### Fourth Embodiment

In a fourth embodiment, the invention is applied to a refilled liquid container. A supply maker of an ink cartridge 100 makes an effort to re-use a resource by recovering a used ink cartridge 100 from a consumer and refilling ink to an ink pack 107.

As shown in FIG. 8, the recovered ink cartridge 100 is dissembled to refill the ink to the ink pack 107. At this time, the sealing film F2 shown in FIG. 3 and the sealing film 156 shown in FIG. 10 have originally the notch portion C or a notch portion torn by an ink lead-out needle. However, an ink cartridge to which the invention can be applied has to include a structure in which peripheral portions of the sealing films F2 and 156 are thermally welded to the ink lead-out portion 32b and 109 and a sealing member therein. That is, the sealing member has to maintain the sealing characteristic. In this case, removing the thermally welded sealing films F2 and 156 is a considerably difficult operation.

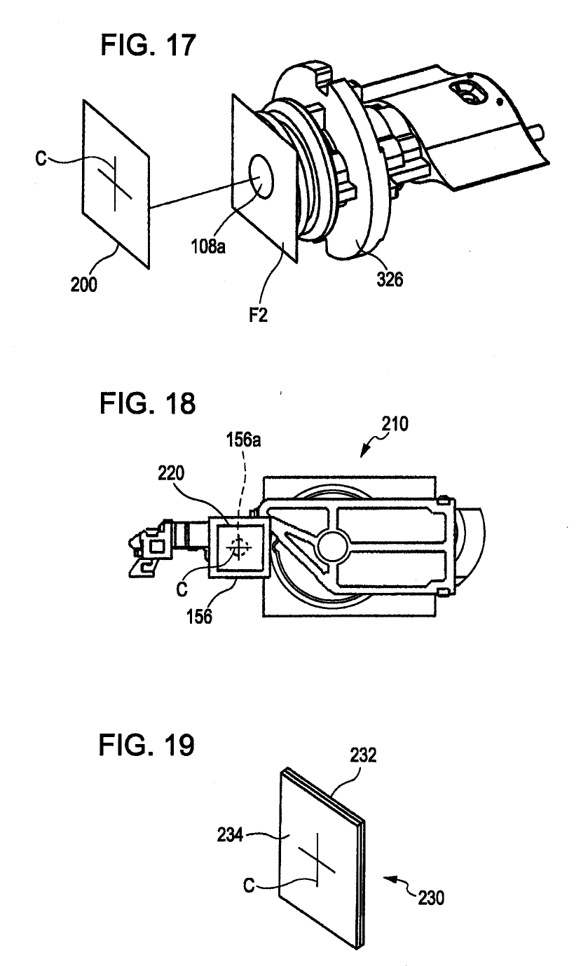

Accordingly, as shown in FIG. 17, a coating film 200 is attached onto a sealing film 108 thermally welded to the ink lead-out portion 32b so as to cover the notch portion of the sealing film F2 or a torn portion 108a. Accordingly, since the used notch portion or the torn portion 108a is not exposed, a commodity value of the recovered ink cartridge can be guaranteed. A method of attaching the coating film 200 may be performed by thermal welding, gluing, adhering, or the like. In the thermal welding operation, a material of the coating film 200 is the same as that of the sealing film F2. However, in the other attaching, any material thereof can be used. That is, the coating film 200 can be used as long as it is a thin membrane-shaped film, and can be formed of, for example, a paper sheet, a fiber material such as cloth, a nonwoven sheet, or a nonwoven fabric.

In the present embodiment, the notch portion C is also formed in the coating film 200. The notch portion C may be formed of a notch or a hole like the first embodiment.

With such as configuration, the refilled liquid container is re-used. Upon filling a liquid, a liquid filling member is inserted into a liquid passage through the notch portion C of the coating film 200 and the notch portion or the torn portion 108a formed in the sealing film F2. In addition, upon leading out the liquid, a liquid lead-out member is inserted into a liquid passage through the notch portion C of the coating film 200 and the notch portion or the torn portion 108a formed in the sealing film F2.

The coating film 200 may be also coated to the sealing film 156 having the notch portion C or the torn portion in the same manner. FIG. 18 is a diagram illustrating a re-using liquid level detecting unit 210 having a structure different from that of the liquid level detecting unit 111 shown in FIGS. 10 to 12. In the re-using liquid level detecting unit 210, a coating film 220 covers a torn portion 156a of the sealing film 156 to be attached.

In this way, it is possible to re-use the ink cartridge 100 according to the third embodiment as the refilled liquid container while re-using the sealing function of the sealing films F2 and 156 just by coating the torn sealing films F2 and 156 with the coating films 200 and 220. As a result, a commodity value of the recovered ink cartridge can be guaranteed.

### Fifth Embodiment

In a fifth embodiment of the invention, modification examples of the sealing film will be described. In the modification examples, the invention may be applied to any one of the above-described sealing films F2, 108, and 156. As shown in FIG. 19, a sealing film 230 may be formed of a plural-layered film, for example, a two-layered film. In this case, a first-layer film 232 facing an ink lead-out portion may be formed of the above-described material which can be thermally welded to the ink lead-out portion, the sealing member, and the case body. In addition, a second-layer film 234 may be formed of a material which has a melting point higher than that of the first-layer film 232. In this way, since the second-layer film 234 is not melted at a temperature at which the first-layer film 232 is melted, the shape of the sealing film 230 can be retained even after the thermal welding. In a case where the first-layer film 232 is formed of polyprophylene, polyethylene, etc., as a material of the second-layer film 234, polyethylene terephthalate (PET) or polyimide (PA) is appropriate. In addition, in a case where the sealing film is formed of a plurality of layers, a plurality of the notch portions C shown in FIG. 19 are formed in the plurality of layers.

### Sixth Embodiment

Hereinafter, a method of manufacturing a liquid sealing structure in which a notch portion C is formed in a sealing film will be described. Forming the notch portion in the sealing film may be performed before the sealing film is thermally welded or after the sealing film is thermally welded. When the notch portion is formed in the sealing film after the thermal welding, a processing instrument provided in an apparatus used in the thermal welding can be used, for example.

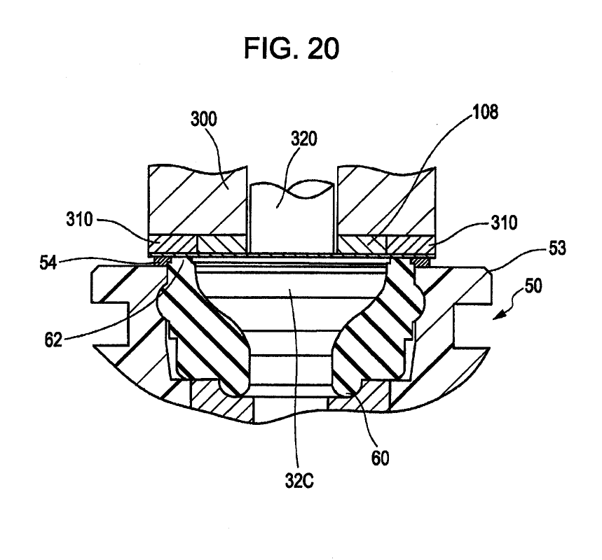

FIG. 20 shows a case where a sealing film 108 is thermally welded to the ink lead-out portion 50 shown in FIG. 7, for example. In the thermal welding, the sealing film 108 is thermally welded to a thermal welding support 62 of a sealing member 60 and a thermally welding circular support 54 of an ink lead-out portion 50. A thermal welding jig 300 includes a thermal welding portion 310 such as an ultrasonic vibrator and a notch portion forming jig 320. The notch portion forming jig 320 can advance and retreat, for example, and forms the notch portion C in the sealing film 108 after the thermal welding. As a method of forming the notch portion C, melting by heat, cutting by a cutter, a combination thereof, etc. can be used.

After the notch portion C is formed in the sealing film 108 using a thermal welding jig in this way, the ink lead-out portion 50 is connected to an empty ink pack 107b containing a liquid. Subsequently, the ink filling member (not shown) is inserted into a liquid passage 32d through the notch portion C of the sealing film 108 and the ink filling member opens valve mechanisms 34 and 35 to fill a liquid in the ink pack 107b. In this way, in addition to the ink lead-out member, the ink filling member can pass through the notch portion C of the sealing film 102. Of course, the ink lead-out portion 50 may be connected to the empty ink pack 107b before the sealing film 108 is thermally welded to fill a liquid in the ink pack 107.

In a case where the notch portion C is formed using the jig shown in FIG. 20, the notch shown in FIG. 3 is preferable more than the hole shown in FIG. 6. That is because broken pieces separated from the sealing film 108 are not generated. In a case where the hole is formed, the broken pieces may be attached, for example, so as not to fall the broken pieces to the inside of the sealing member 60.

As well as forming the notch portion C in the sealing film in the thermal welding in this way, the notch portion may be formed in the sealing film when the sealing film is thermally welded and the ink pack is filled with a liquid. That is, an ink filling needle (not shown) is inserted into the liquid passage 32d through the sealing film 108 and the ink lead-out portion 50 to open the valve mechanisms 34 and 35 and fill a liquid in the ink pack 107b. In the filling of the liquid, the sealing film 108 is torn by the acute ink filling needle, thereby forming the notch portion C in the sealing film 108. That is, since the notch portion C can be formed in the filling of the liquid, the number of operations is not increased.

The above-described embodiments have been described in detail, but it should be understood that the invention may be modified without substantially departing from newness and advantages of the invention. Accordingly, such modification is included in the invention. For example, terms described along with other terms in a broad sense or an equivalent sense at least once in the specification or the drawings can be substituted by other terms in the specification or the drawings.

In the above-described embodiments, the liquid ejecting apparatus may be embodied in a so-called full line type (line head type) printer in which a printing head 19 in a direction intersecting a transport direction (front and rear directions) of a printing sheet (not shown) has a shape so as to correspond to the length of the printing sheet (not shown) in a width direction (transverse direction).

The liquid sealing structure and the liquid container according to the invention is not limited to the ink cartridge of the ink jet type printing apparatus. The liquid sealing structure and the liquid container may be used in a liquid consuming apparatus.

In the above-described embodiments, the liquid ejecting apparatus is embodied in the ink jet type printer 11. However, the invention is not limited thereto, but the liquid ejecting apparatus may be embodied in a liquid ejecting apparatus capable of spraying or ejecting another liquid (including a liquid formed by dispersing or mixing particles of a functional material in a liquid or a liquefied form such as gel). For example, the liquid ejecting apparatus may be a liquid ejecting apparatus which ejects a liquid in a dispersing or dissolving form of a material such as an electrode material or a color material (pixel material) used to manufacture a liquid crystal display, an EL (electro luminance) display, and a plane emission display, a liquid ejecting apparatus which ejects a bio-organism used to manufacture a bio chip, or a liquid ejecting apparatus which is used as a precise pipette to eject a liquid as a sample. Moreover, the liquid ejecting apparatus may be a liquid ejecting apparatus which ejects lubricating oil to a precise instrument such as a watch or a camera, a liquid ejecting apparatus which ejects a transparent resin liquid such as an ultraviolet curable resin to form a small hemispherical lens used in an optical communication element, a liquid ejecting apparatus which ejects an acid or alkali etching liquid to etch a substrate or the like, or an liquefied-form ejecting apparatus which ejects a liquefied form such as gel (for example, physical gel). In addition, the invention may be applied to one of the mentioned liquid ejecting apparatuses. In the specification of the invention, “the liquid” refers to a liquid which is not formed only by a gas. The liquid includes an inorganic solvent, an organic solvent, a solution, a liquefied resin, a liquefied metal (metal solution), a liquid itself, and a liquefied form.

The entire disclosure of Japanese Patent Application Nos: 2007-37993, filed Feb. 19, 2007 and 2007-79755, filed Jul. 9, 2007 are expressly incorporated by reference herein.

What is claimed is:

1. A liquid container having a liquid containing member which contains ink, and a liquid sealing structure connected to the liquid containing member, the liquid sealing structure comprising:
a liquid lead-out portion which has a liquid passage and an opening end surface formed in a liquid lead-out end of the liquid passage;
a sealing member which is disposed on the opening end surface inside the liquid passage;
a valve mechanism which is disposed inside the sealing member in the liquid passage to close the liquid passage; and
a sealing film which covers the liquid passage and the opening end surface of the liquid lead-out portion and is thermally welded to the opening end surface and the sealing member,
wherein a notch portion for passing a liquid lead-out member which is inserted into the liquid passage to open the valve mechanism is formed in the sealing film.

2. The liquid container according to claim 1, wherein the notch portion is a hole.

3. The liquid container according to claim 1, wherein the notch portion is a plurality of notches extending radially from the center point thereof.

4. The liquid container according to claim 1, wherein the sealing member is formed of an elastic ring having a hole through which the liquid lead-out member is closely inserted.

5. The liquid container according to claim 4, wherein the valve mechanism includes a movable valve member which is disposed to come in contact with the sealing member inside the liquid passage and an urging member that urges the valve member to come in pressing contact with the sealing member, and
wherein the sealing member serves as a valve sheet member which comes in contact with the valve member to close the liquid passage before the liquid lead-out member is inserted through the sealing member, and the valve member is separated from the sealing member against an urging force of the urging member by the liquid lead-out member to open the liquid passage when the liquid lead-out member passes through the sealing film to be inserted into the liquid passage.

6. The liquid container according to claim 1, further comprising a case provided with a space for receiving the liquid containing member and the liquid sealing structure,
wherein the case includes a pressurizing port which introduces a pressurizing fluid for feeding a liquid contained in the liquid containing member and an opening which exposes the opening end surface of the liquid sealing structure, and
wherein the sealing film is thermally welded to the case around the opening.

7. The liquid container according to claim 1, further comprising a liquid level detecting unit including a liquid lead-out port, wherein the liquid sealing structure is connected to the liquid lead-out port.

8. The liquid container according to claim 7, wherein the liquid lead-out member is inserted in the liquid passage through the notch portion of the sealing member.

9. The liquid container according to claim 8, wherein the liquid lead-out member includes a cylindrical member having a flow passage formed therein and a slit which is formed from an insertion end surface of the cylindrical member toward a circumferential wall of the cylindrical member to communicate with the flow passage, and
wherein the insertion end surface of the cylindrical member has a flat surface.

10. The liquid container according to claim 1, further comprising a coating film attached onto the sealing film, wherein a notch portion for passing the liquid lead-out member inserted into the liquid passage is formed in the coating film.

11. A method of manufacturing a liquid container having a liquid sealing structure which includes a liquid lead-out portion which has a liquid passage and an opening end surface formed in a liquid lead-out end of the liquid passage, a sealing member which is disposed on the opening end surface inside the liquid passage, and a valve mechanism which is disposed inside the sealing member in the liquid passage to close the liquid passage, the method comprising:
manufacturing the liquid sealing structure by disposing the valve mechanism and the sealing member inside the liquid passage of the liquid lead-out portion, thermally welding a sealing film to the opening end surface and the sealing member of the liquid lead-out portion, and forming in the sealing film a notch portion for passing a liquid lead-out member which is inserted into the liquid passage to open the valve mechanism is formed in the sealing film before or after the thermal welding;
connecting the liquid sealing structure to a liquid containing member containing a liquid;
filling the liquid in the liquid containing member by inserting a liquid filling member into the liquid passage through the notch portion of the sealing film, and opening the valve mechanism by the use of the liquid filling member; and
disposing the liquid containing member and the liquid sealing structure in a case.

12. The method according to claim 11, further comprising disposing the sealing member so as to be substantially flush with the opening end surface before the thermal welding.

13. The method according to claim 11, wherein the notch portion is formed in the sealing film by a processing instrument provided in an apparatus used in the thermal welding after the thermal welding.

14. The method according to claim 11, wherein a liquid level detecting unit is disposed in the case and the liquid sealing structure and the liquid level detecting unit are connected to each other by inserting the liquid lead-out member provided in the liquid level detecting unit into the liquid passage through the notch portion of the sealing film.

15. The method according to claim 11, wherein in the filling of the liquid, the liquid filling needle tears the sealing film and the notch portion for passing the liquid lead-out member which is inserted into the liquid passage to open the valve mechanism is formed in the sealing film.

16. A method of refilling a liquid container including a liquid containing member which contains a liquid and a liquid sealing structure which is connected to the liquid containing member, in which a liquid container is recovered and the liquid containing member is refilled with a liquid, the liquid sealing structure including a liquid lead-out portion which has a liquid passage and an opening end surface formed in a liquid lead-out end of the liquid passage, a sealing member which is disposed on the opening end surface inside the liquid passage, a valve mechanism which is disposed inside the sealing member in the liquid passage to close the liquid passage and a sealing film which covers the liquid passage and the opening end surface of the liquid lead-out portion and is thermally welded to the opening end surface and the sealing member, and in which before the recovery, the valve mechanism is opened by inserting a liquid lead-out needle into the liquid passage with the sealing film interposed therebetween to lead out the liquid contained in the liquid containing member, the method comprising:
refilling the liquid to the liquid containing member while maintaining sealing of the opening end surface by the thermal welding of the sealing film to the opening end surface and the sealing member; and
attaching a coating film for coating the sealing film onto the sealing film after the refilling,
wherein a notch portion for passing the liquid lead-out member re-inserted into the liquid passage after the refilling is formed in the coating film.
